(19) United States
(12) Patent Application Publication
(10) Pub. No.: US 2020/0192639 A1
(43) Pub. Date: Jun. 18, 2020

(54) MODELING OF DATA GENERATON SCENARIOS

(71) Applicant: SAP SE, Walldorf (DE)

(72) Inventors: Stefan Rau, Dielheim (DE); Uwe Bloching, Nussloch (DE)

(21) Appl. No.: 16/220,359

(22) Filed: Dec. 14, 2018

(51) Int. Cl. G06F 8/35; G06F 9/54; G06F 9/451

(52) U.S. Cl. CPC G06F 8/35; G06F 9/451; G06F 9/547

(57) ABSTRACT

A scenario is specified for data generation. User interface parameters associated with a data generation program and for controlling the data generation are specified. One or more entities associated with the scenario are described. One or more nodes associated with each entity of the one or more entities are described. One or more properties associated with each node of the one or more nodes are described. One or more attributes for each node of the one or more nodes are described. Generated data is received from generated and called data generation program code.

### BACKGROUND

Data generation is widely used for, among other things, development, test, simulation, and performance analysis of software and computing systems. Traditional data generation applications permit software development teams to dynamically and automatically generate large amounts of data in a short period of time to meet desired patterns of data for testing, demonstration, or analysis requirements. There is often a requirement for large amounts of generated data, as well as a requirement for the generated data to be well-defined, abstracted, and diffuse. However, use of the traditional data generation tools require coding knowledge to combine data generation models to create data generation code.

### SUMMARY

The present disclosure describes creation of data generation code using high-level modeling descriptions.

In an implementation, a scenario is specified for data generation. User interface parameters associated with a data generation program and for controlling the data generation are specified. One or more entities associated with the scenario are described. One or more nodes associated with each entity of the one or more entities are described. One or more properties associated with each node of the one or more nodes are described. One or more attributes for each node of the one or more nodes are described. Generated data is received from generated and called data generation program code.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. The essence of the described methodology is not to generate code, but that, instead of code fragments, complete user-specific software applications (that is, data generators) can be created based on a high-level model description and without the requirement for software coding knowledge. The created software applications are ready to run without a requirement to generate additional interface/embedding code. The generated software applications can also be shared and used by others (for example, members of a software development team/group or other groups) for particular data generation requirements. In this way, both sides to a data transaction have the ability to generate data and independently test software applications with the same generated data to ensure uniformity of testing and to test software application response/performance. The ability to dynamically create data generators is useful in, as an example, computer science and software development disciplines. For example, data processing techniques and optimization can be designed, implemented, and analyzed with easy access to easily accessible data sets generated by data generators. As a particular example, the described methodology permits automated and dynamically alterable code generators to be created by automated processes on-the-fly and in response to dynamically changing computing or network conditions. Created data generators can generate data in combinations and with a frequency that is not possible by traditional manual methods to permit real-time or near real-time load and other testing of software applications and associated computing and network systems. The generated data can be used to test increasingly high-performance computing and network systems for errors and optimization issues also not discoverable by traditional manual methods. Data can also be generated in a manner to reproduce known prior conditions to permit dynamic and precise legacy/regression testing in an optimized manner. The described methodology also simplifies overall software testing, which encourages more rigorous testing practices and enhances overall software quality. The described methodology moves data generation complexity to an entity-level (for example, an organization or business) and away from only at a technical-level. Since the generated data is artificial, data privacy violations are avoided. The generated data can also be used for simulations and what-if-type scenarios.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 illustrates an example graphical user interface (GUI) for defining an example scenario, according to an implementation of the present disclosure.

FIG. 2 illustrates an example GUI for defining user UI parameters for the scenario of FIG. 1, according to an implementation of the present disclosure.

FIG. 3 illustrates an example GUI for defining an entity name for the scenario of FIG. 1, according to an implementation of the present disclosure.

FIG. 4 illustrates an example GUI for describing a node for the entity of FIG. 3, according to an implementation of the present disclosure.

FIG. 5 illustrates an example GUI for describing properties for the node of FIG. 4, according to an implementation of the present disclosure.

FIG. 6 illustrates an example GUI for describing attributes for the database (that is, “SNWD_ARTISTS”) described in FIGS. 4-5, according to an implementation of the present disclosure.

FIG. 7 illustrates an example relationship of different rule types and rule set objects, according to an implementation of the present disclosure.

FIG. 8 illustrates an example relationship of how a model description is transformed into code and how generated artifacts are embedded into a data generation framework, according to an implementation of the present disclosure.

FIG. 9 is an example created data generator program (report), according to an implementation of the present disclosure.

FIG. 10 is a swim diagram illustrating an example of a computer-implemented method or initialization of a data generation program UI, according to an implementation of the present disclosure.

FIG. 11 is a swim diagram illustrating an example of a computer-implemented method for UI interaction, according to an implementation of the present disclosure.

FIG. 12 is a swim diagram illustrating an example of a computer-implemented method for checking combinations of parameters, according to an implementation of the present disclosure.

FIG. 13 is a swim diagram illustrating an example of a computer-implemented method for connecting model instances, according to an implementation of the present disclosure.

FIG. 14 is a swim diagram illustrating an example of a computer-implemented method for processing each entity, according to an implementation of the present disclosure.

FIG. 15 is an example of an individual method implementation for an attribute rule, according to an implementation of the present disclosure.

FIG. 16 is a line in a scenario definition UI corresponding to definition of an attribute rule in FIG. 15, according to an implementation of the present disclosure.

FIG. 17 is a swim diagram illustrating an example of a computer-implemented method for creating attribute rules, according to an implementation of the present disclosure.

FIG. 18 is a swim diagram illustrating an example of a computer-implemented method for generating an entity class for each entity, according to an implementation of the present disclosure.

FIG. 19 is an example of an implementation of a specific property, according to an implementation of the present disclosure.

FIG. 20 is a swim diagram illustrating an example of a computer-implemented method for connecting model instances, according to an implementation of the present disclosure.

FIG. 21 is an example of class used for common used objects, according to an implementation of the present disclosure.

FIG. 22 is a swim diagram illustrating an example of a computer-implemented method for specifying a number of table entries to be created, according to an implementation of the present disclosure.

FIG. 23 is an example of an interface artifact describing database table structures, according to an implementation of the present disclosure.

FIG. 24 is a flowchart illustrating an example of a computer-implemented method for creation of data generation code using high-level modeling descriptions, according to an implementation of the present disclosure.

FIG. 25 is a block diagram illustrating an example of a computer-implemented System used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes creation of data generation code using high-level modeling descriptions, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Data generation is widely used for, among other things consistent with this disclosure, development, test, simulation, and performance analysis of software and computing systems. Traditional data generation applications permit software development teams to dynamically and automatically generate large amounts of data in a short period of time to meet desired patterns of data for testing, demonstration, or analysis requirements. There is often a requirement for large amounts of generated data, as well as a requirement for the generated data to be well-defined, abstracted, and diverse. However, use of the traditional data generation tools require coding knowledge to combine data generation models to create data generation code.

For example, in some model-driven data generators, data generation rules (or artifacts) can be combined to form highly-sophisticated, complex data generation scenarios. In these implementations, the model-driven data generators are based on a generic data generation framework and all data generation rules are embedded into the data generation framework for processing. It is a technical issue that particular combinations of data generation rules are required to be manually coded (for example, by a software or systems engineer) and that this effort must be repeated for individual software projects, even though differences between projects may be minimal. As an example, the following artifacts are typically manually created for each particular data generation project:
Global scenario class—one class required,
Local scenario classes—one included containing one local class per entity,
Entity classes—one class per entity required,
Unit test classes for entity classes—one class per entity required,
Property classes—one per manually implemented property (optional—depending on requirements),
Class for common used objects—one class required per project,
Report—main entry point into a data generation scenario. Users call the report to start a data generator. The report is a user interface (UI) part of a data generator. The report triggers verification of data generation parameters and, if the data generation parameters are valid, the report triggers data generation by calling a corresponding method of a global scenario class. In some implementations, the report can show parameters defined by the one creates the data generator model creator, defined parameters, and a graphical trigger element (for example, a start button).
Interfaces, describing database table structures—one interface per table required.

Service calls are defined on an Entity-level and nodes are integral parts of a service (for example, a service can be compared with a data object—such as a purchase order containing a header (a node) and items (a separate node)). If a database is used as a target, then granularity is directly at a node-level. An entity is used to cover nodes that are to be generated together. Within an entity, dependencies can be defined between attributes. Between entities, dependencies are not definable.

Most effort in implementation of a data generation project is creation of the mentioned artifacts and writing of glue code to embed the artifacts into the data generation framework. Artifact code can be generated using code generation applications. As the artifacts are similar with respect to different data generation projects, the artifact code can be generated with basic functionality and based on a model description. However, embedding the generated artifact code within the data generation framework currently requires manual effort with manually created glue code.

The essence of the described methodology is not to generate code, but that, instead of code fragments, a complete user-specific software application (that is, a data generator) can be created based on a high-level model description and without a requirement for software coding knowledge. The created software applications are ready to run without a requirement to generate additional interface/embedding code. The generated software applications can also be shared and used by others (for example, members of a software development team/group or other groups) for particular data generation requirements. In this way, both sides to a data transaction have the ability to generate data and independently test software applications with the same generated data to ensure uniformity of testing and to test software application response/performance.

As previously mentioned, the created data generators can be used to generate data useful for, among other things consistent with this disclosure, development, test, and performance analysis of software and computing systems. In addition to the ability to generate large amounts of data, the generated data can be well-defined, abstract, and diverse. As also previously mentioned, highly-sophisticated, complex data generation scenarios can be formed. For example, created data generator can be configured to permit control using parameters to generated different data sets. As a particular example, data associated with a particular entity in a particular country can be influenced based on used parameters (such as, a percentage of entities required to be in Germany vs. in the United States). In this particular example, percentage value/entity pair data sets can be supplied as one or more parameters. In this way, the created data generator can be flexible without a requirement to rebuild the data generator to vary data sets that can be varied using a parameter change. The provided modeling language can also be configured to permit, among other things, the use of aggregations functions, numerical distributions, mathematical formulas, logical relationships, data field dependencies, or any other data relationship consistent with this disclosure and the described subject matter and as understood by one of ordinary skill in the art.

The ability to dynamically create data generators is useful in, as an example, computer science and software development disciplines. For example, data processing techniques and optimization can be designed, implemented, and analyzed with easy access to easily accessible data sets generated by data generators. As a particular example, the described methodology permits automated and dynamically alterable code generators to be created by automated processes on-the-fly and in response to dynamically changing computing or network conditions. Created data generators can generate data in combinations and with a frequency that is not possible by traditional manual methods to permit real-time or near real-time load and other testing of software applications and associated computing and network systems. The generated data can be used to test increasingly high-performance computing and network systems for errors and optimization issues also not discoverable by traditional manual methods. Data can also be generated in a manner to reproduce known prior conditions to permit dynamic and precise legacy/regression testing in an optimized manner. The described methodology also simplifies overall software testing, which encourages more rigorous testing practices and enhances overall software quality.

In some implementations, the described data generators use two separate personas: 1) data generation model experts (or “model experts”) and 2) model users. In contrast, traditional data generators require a third persona, a data creation expert, which increases the overall complexity and decreases the flexibility of the traditional data generation solution. A model expert can be considered to have domain knowledge that is required for modeling of pattern-driven data generation scenarios. In one example, a model expert could be a person with knowledge to transfer a particular use case (such as, data analysis, performance testing, or a business model) into a data generation scenario. On the other hand, model users can be considered to be those that requires generated data and wish to self-generate data but lack or do not wish to gain necessary knowledge possessed by model experts. For example, a model user could be a software testing engineer that requires generated data for testing purposes or marketing personnel that need generated data to develop and engage in realistic demonstrations.

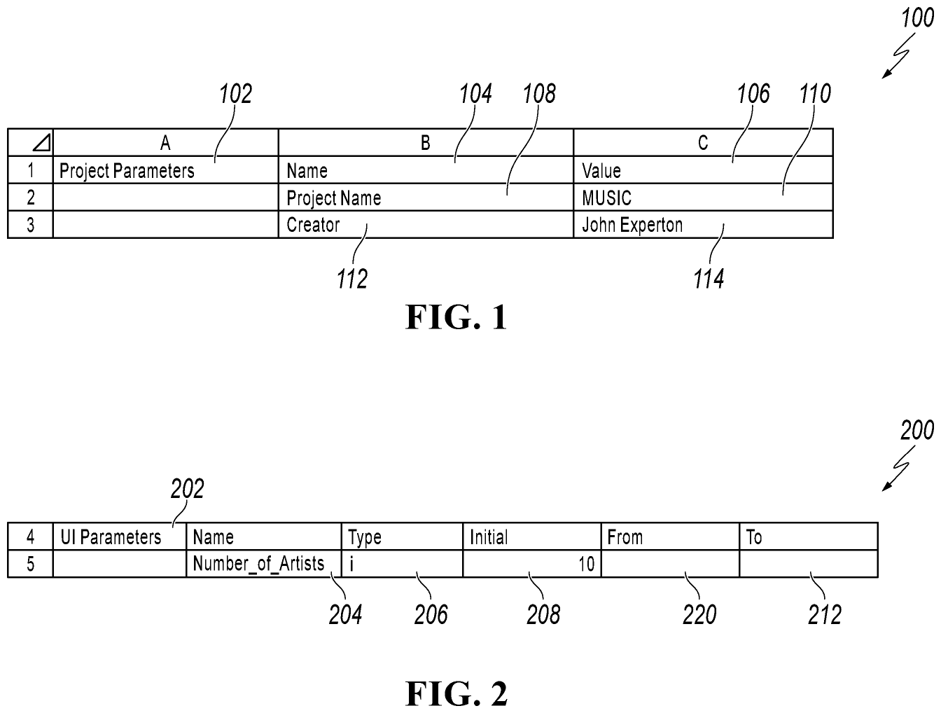

FIGS. 1-6 illustrate an example graphical user interface (GUI) for creating data generation code for a data generator software application. As will be appreciated by those of ordinary skill in the art, the provided example is only one possible example of GUI design or process flow to accomplish the described methodology, and is provided to enhance understanding. The provided example is not meant to be limiting in any way.

In some implementations, each data generator consists of different artifacts, including:
1. One Scenario,
2. Minimum one Entity per Scenario,
3. Minimum one Node per Entity,
4. Minimum one Property per Node,
5. Exactly one Attribute per Node, and
6. Optionally there is a set of parameters that are used for UI inputs. Their purpose is to control the data generation process, e.g. the number of data records to be created.

A scenario is considered to be the top-level of any data generator model and is an assembly of data generation rules for columns (attributes) of the different node databases that are required for a scenario. Examples of a scenario can include a simple data table with entity address data, a combination of different tables (such as, examining entity behavior(s)), or a complex scenario including multiple interlinked data objects. In some implementations, parameters used at a scenario-level are project name and a responsible contact for the scenario (for example, a model expert, an automated process(es), or a combination of the two).

Referring to FIG. 1, FIG. 1 illustrates an example GUI 100 for defining an example scenario, according to an implementation of the present disclosure. As illustrated in FIG. 1, project parameters 102 include both name 104 (responsible contact) and value 106. The name of applicable project parameters for the example scenario are “Project Name” 108 (here, with a value 110 of “MUSIC”) and Creator 112 (here, with a value 114 of “John Experton”). Note that the example GUI 100 is a portion of a spreadsheet, the same or other portions which are also used in FIGS. 2-6, 19, and 21. While FIG. 1 illustrates a spreadsheet, other types of UI' s or editors can be used for defining a scenario. In this example, the spreadsheet with associated data is typically created by a model expert. Note that, in some implementations, the described methodology can use the entered project name (here, “MUSIC”) as a suffix for created code artifacts.

User interface (UI) parameters are used for controlling a data generation process (for example, controlling a number of data records to be generated) and is optional. For example, a report can be an automatically generated GUI interface that can be started by a model user and possesses fields for specified parameters to be entered. In some implementations, generated code can be compiled automatically (and transparently to a user). In other implementations, the generated code need not be compiled as particular programming languages may interpret code. A user can executes the generated code (as a program) and find generated data in a persistency defined with the model (for example, refer to FIG. 4, element 416 where data is stored in database table SNWD_ARTISTS). In some implementations, the persistency can be other than a database and include, for example, flat files, CSV files, or other files/data storage structures. The generated data can then be accessed in a manner suitable for a consumer of the generated data (for example, by applications to be demonstrated based on the generated data or a software test framework can access the generated data to supply the generated data to software unit tests).

FIG. 2 illustrates an example GUI 200 for defining user UI parameters for the scenario of FIG. 1, according to an implementation of the present disclosure. As illustrated in FIG. 2, UI parameters 202 include Name 204 (here “Number_of_Artists”), Type 206 (here, “I”-integer), Initial 208 value when starting an associated data generator (here, “10”), and optional From 210/To 212 values to specify a permissible value range for the parameter 104 (here, no values are specified).

A data generation entity is a bracket around several nodes (also to the discussion associated with FIG. 4) and specifies that the nodes are to be combined and generated together. In some implementations, the data generation entity indicates that nodes within the data generation entity may depend upon each other (for example, logical dependencies or physical dependencies).

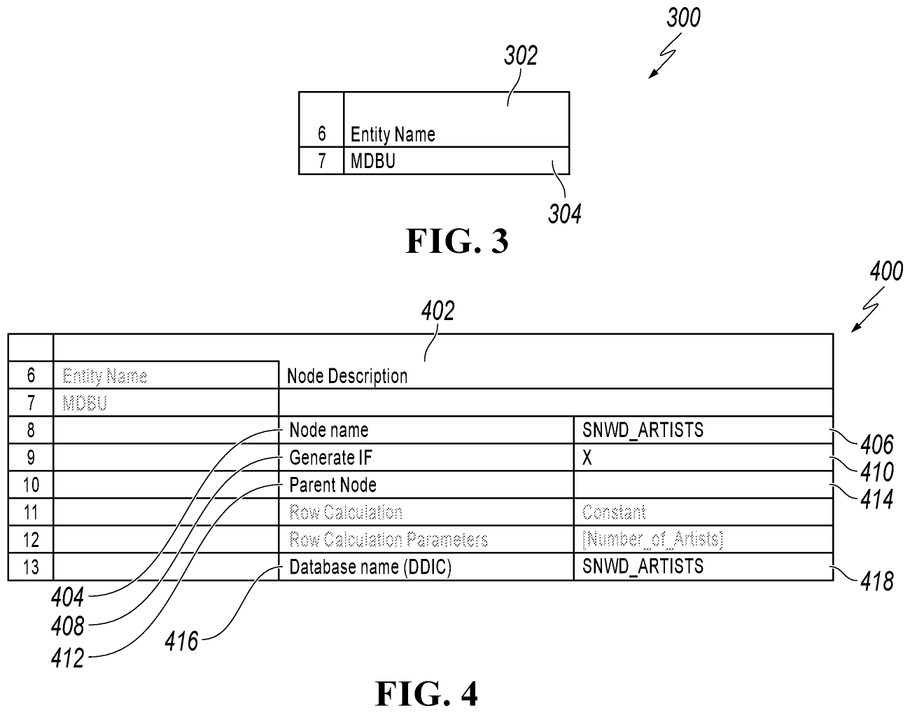

FIG. 3 illustrates an example GUI 300 for defining an entity name for the scenario of FIG. 1, according to an implementation of the present disclosure. In typical implementations, an entity only has a name as a parameter. As illustrated in FIG. 3, entity name 302 is specified with a value 304 of “MDBU”. In some implementations, the value 304 is used as part of a name of created entity-specific code artifacts. An entity describes a collection of data tables. The collection of tables belongs together and possesses strong semantic relationships (parent-child).

A node represents a persistency artifact (for example, a database table) that stores generated data. In the case of a database table, the node describes (using defined rules) a number of database rows to be generated. In some implementations, nodes within an entity (such as, entity “MDBU” in FIG. 3) may have structural dependencies (for example, parent-child or other types of relationships). In this case, in addition to a name of a particular node, identification of a parent node is required (if the node is not a header node). A connection to a physical data persistency is also required as well (such as, a database). In some cases, a database table can be modeled to be used by different nodes. In this case, it makes no sense to create a corresponding interface multiple times. Here, the corresponding interface can be created on a single nodes (note that this behavior is controlled in this example by a flag “Generate IF”).

Turning to FIG. 4, FIG. 4 illustrates an example GUI 400 for describing a node for the entity of FIG. 3, according to an implementation of the present disclosure. As illustrated in FIG. 4, node description 402 is specified with a node name 404 (here, a value 406 of “SNWD_ARTISTS”), generate if flag 408 (as previously described) (here, a value 410 of “X”), parent node 412 (here, no value 414), and database name (DDIC) 416 (here, a value 418 of “SNWD_ARTISTS”). In some implementations, the value 304 is used as part of a name of created entity-specific code artifacts. In typical implementations, the node SNWD_ARTISTS will generate data into a database table of the same name. As the node specified in FIG. 4 is a header node, creating an interface (specifying values 416 and 418) is required.

A property describes behavior of a node and is responsible for calculating a number of entries into a to-be-created node database table. In some implementations, predefined properties can be made available for use. In some implementations, a user can also implement personalized properties for use.

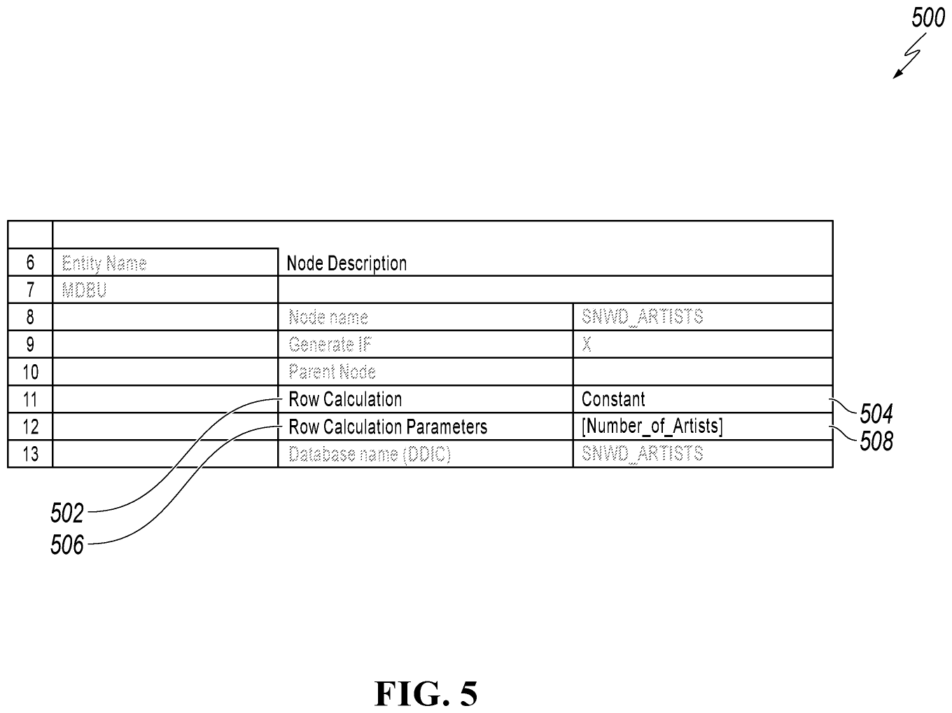

Turning to FIG. 5, FIG. 5 illustrates an example GUI 500 for describing properties for the node of FIG. 4, according to an implementation of the present disclosure. As illustrated in FIG. 5, properties include row calculation 502 (here, a value 504 of “Constant”) and row calculation parameters 506 (here, a value 508 of “[Number_of_Artists]”). In this example, a constant number of rows will be created for the given database table. The number of rows is to be taken from the GUI (refer to FIG. 2) at runtime. FIG. 5 demonstrates that UI parameter “Number_of_Artists” (204) is connected to an input (value 508) of field Row Calculation Parameters 506.

An attribute corresponds to an explicit column of a node database table and describes content to be generated (that is, data patterns) to fill the column. Attribute rules can be defined for single Attributes or on sets of Attributes (called attribute tuples). The attribute rules are responsible for generating data to be written to the database and can implement different algorithms for creating data. In some implementations, each attribute rule can have a set of parameters for specifying the particular behavior of the attribute rule.

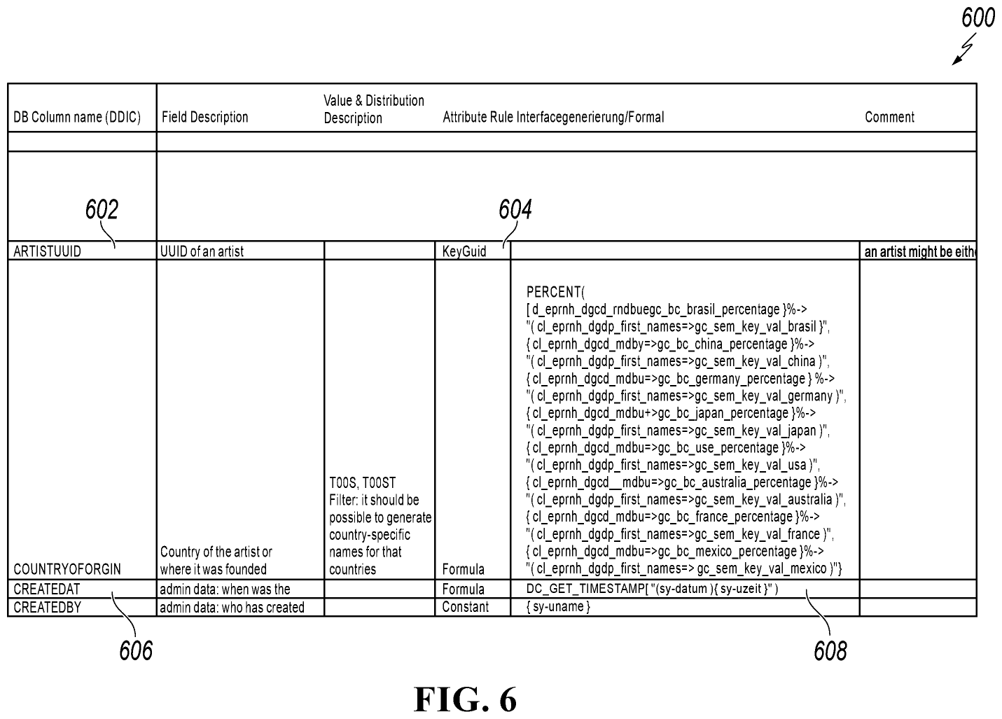

FIG. 6 illustrates an example GUI 600 for describing attributes for the database (that is, “SNWD_ARTISTS”) described in FIGS. 4-5, according to an implementation of the present disclosure. As illustrated in FIG. 6, a simple example rule for field “ARTISTUUID” 602 fills an associated column with different UUIDs according to the attribute rule 604 (“KeyGuid”). In field “CREATEDAT” 606, a more complex rule 608 fills an associated column with a timestamp of the current date and time specified by two parameters.

Data generation is based on a pattern concept. For different attributes of data there exist different patterns. For example, an attribute may be a column of a database and patterns may be distributions like constant value.

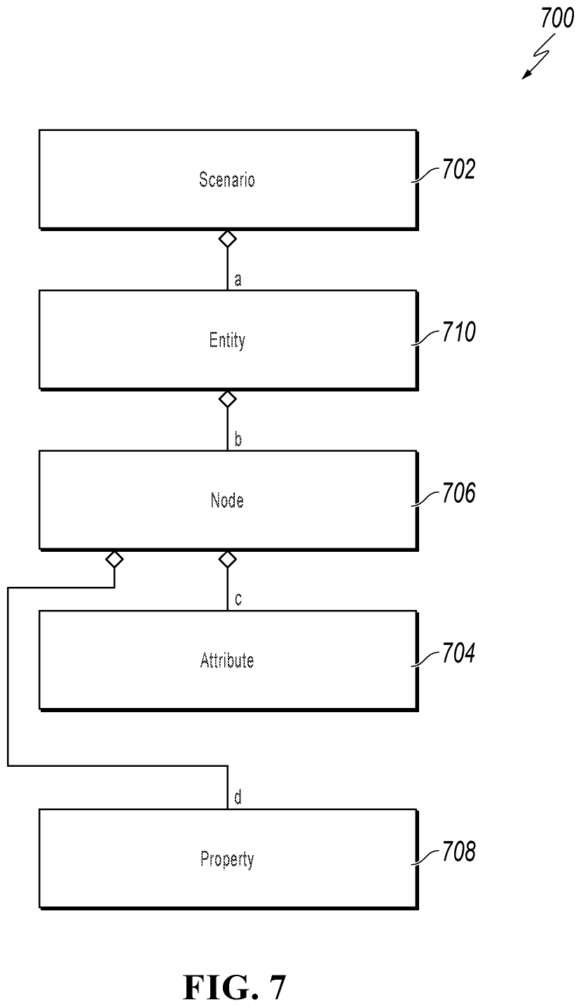

Turning now to FIG. 7, FIG. 7 illustrates an example relationship 700 of different rule types and rule set objects, according to an implementation of the present disclosure. As it is important for user to be able to accurately describe what kind of data is desired to be generated and how the data is to be generated, different rules are provided for this purpose. In some implementations, a particular rule can have parameters and be responsible for creating data in a way that follows a pattern requested by a user. In some implementations, for a given scenario 702, rule types include:
—Attribute rule 704—calculates a value of a specific entity attribute,
Node rule 706—a bracket which contains all node entity attribute rules; responsible for triggering a data generation process for attributes of an entity node,
Property rule 708—describes how a specific property is to be calculated (for example, a number of node elements to be created during a data generator execution), and
Entity rule 710—a bracket which contains all node rules for a given entity; responsible for triggering a data generation process for all assigned entity nodes.
   To create data for a specific scenario, data generator stakeholders provide a corresponding set of rules and an associated set of parameter values. To simplify the task of stakeholders, scenario specific rule objects are provided which stakeholders instantiate and pass parameters to.

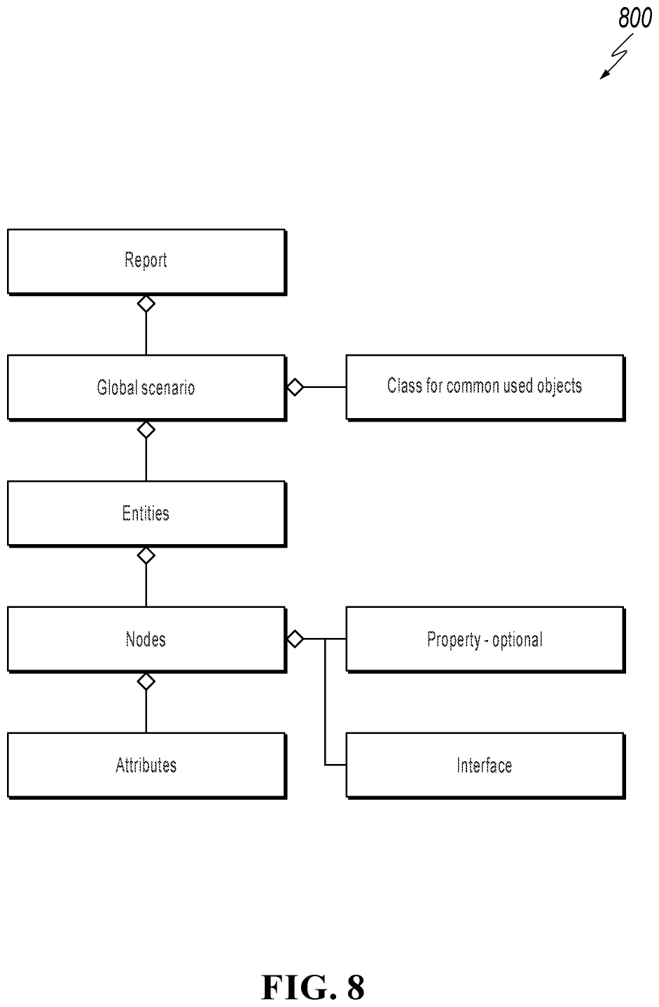

FIG. 8 illustrates an example relationship 800 of how a model description is transformed into code and how generated artifacts are embedded into a data generation framework, according to an implementation of the present disclosure. Embedding means that glue code is generated which makes sure that the generated code artifacts (for example, the previously described artifacts associated with each data generator) are called by the framework in such a way that data is generated as requested. In some implementations, the structure of artifacts is according to FIG. 8. As will be appreciated by those of ordinary skill in the art, FIG. 8 illustrates only one possible structure of artifacts. Any other structure of artifacts consistent with this disclosure is considered to be within the scope of this disclosure. The illustration of FIG. 8 Is not meant to be limiting in any way.

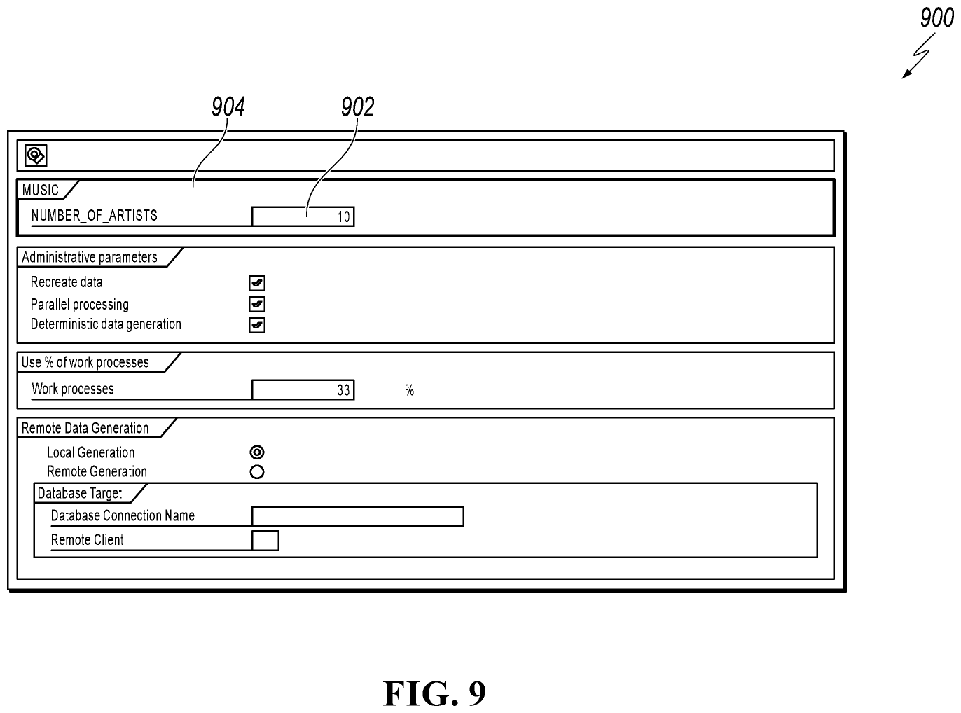

FIG. 9 is an example created data generator program (report) 900, according to an implementation of the present disclosure. In typical implementations, the report 900 is the entry point into a data generation scenario. Model users call the report 900 to start data generation. In some implementations, other type of UIs are possible (for example, a data file, spreadsheet, message, or macro) as well as the use of service providers if no UI required (for example, web services or remote function calls (RFCs). Parameters in box 902 are generated based on the UI parameters description (refer to FIG. 2) and includes an integer data entry field 904 that corresponds with UI parameter field 204 of FIG. 2. In this example, other parameters are part of different standard modules implemented as includes. Note that the illustrated report 900 is directed to the “MUSIC” (110) project name in FIG. 1. Report 900 is generated with no manual coding required by model users.

Note that the following swim diagrams illustrate encapsulation of conventional technology with a state-of-the-art object-oriented paradigm. The swim lane diagrams also illustrate only one possible technical approach for the described methodology. In as much as other illustrations are consistent with the concepts presented by this disclosure, they are considered to be within the scope of this disclosure. The swim diagrams illustrate execution of the described generated code and show which part of a data generator application is generated code, which part is framework, where manually created code required, and how everything is combined. Additionally, the swim diagrams show dependencies between the different parts of a data generator.

With respect to the swim diagrams, the illustrated entities can be subdivided into two logical classes:
Software entities responsible for handling a UI (such as, Report, Report Base, Dialog Includes, Dialog Base) and triggering of a data generation process, and
Software entities responsible for performing data generation and persisting generated data.

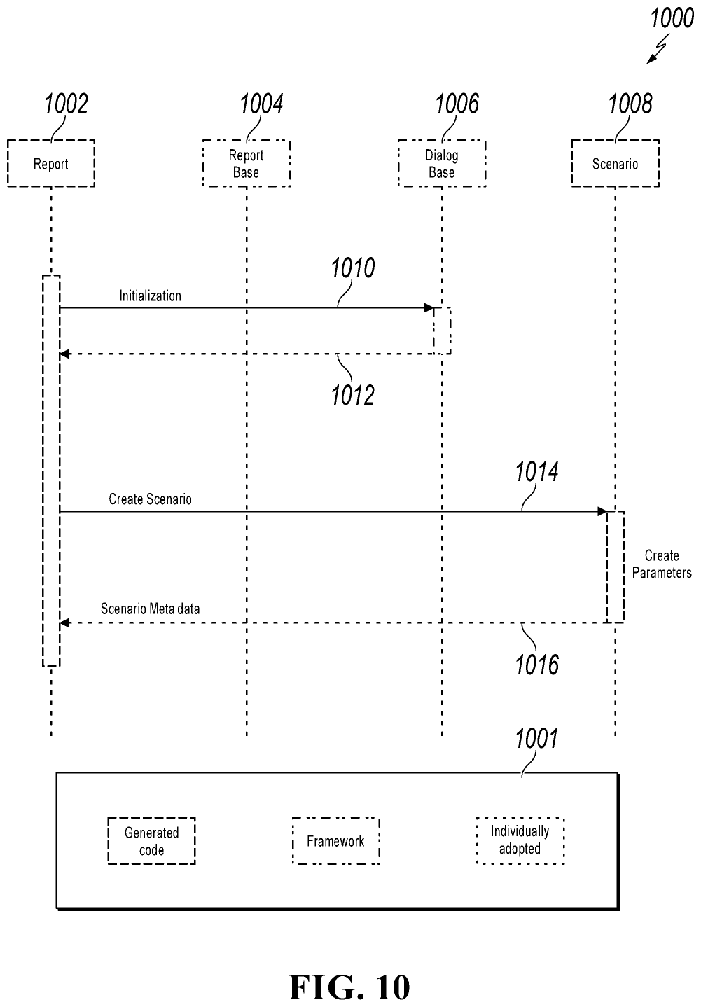

FIG. 10 is a swim diagram illustrating an example of a computer-implemented method 1000 for initialization of a data generation program UI, according to an implementation of the present disclosure. For clarity of presentation, the description that follows generally describes method 1000 in the context of the other figures in this description. However, it will be understood that method 1000 can be performed, for example, by any system, environment, software, and hardware, or a combination of systems, environments, software, and hardware, as appropriate. In some implementations, various steps of method 1000 can be run in parallel, in combination, in loops, or in any order.

Legend 1001 indicates whether various components of the swim diagram 1000 (and other swim diagrams in this disclosure) are generated code, framework, or individually adopted. Generated code specific to a particular data generation scenario and is generated based on the model description (for example, similar to generated UI code in MICROSOFT VISUAL STUDIO). Framework code is static (for example, UI classes) and is used (for example, as the “glue code”) by generated code fragments for different types of data generation scenarios. Individually adopted code is extension code (if necessary) that cannot be automatically generated and must be generated manually.

At 1010, a request for initialization is transmitted from the Report 1002 to the Dialog Base 1006. From 1010, method 1000 proceeds to 1012.

At 1012, the Dialog Base 1006 returns with no data (the UI status is initialized) to the Report 1002. From 1012, method 1000 proceeds to 1014.

At 1014, the Report 1002 requests creation of scenario parameters (for example, refer to FIGS. 2 and 9) from the Scenario 1008. From 1014, method 1000 proceeds to 1016.

At 1016, the Scenario 1008 returns scenario metadata to the Report 1002. The Scenario 1008 defines and creates the scenario metadata for specified UI parameters, which describes the scenario parameters to be displayed on the UI (for example, name, data type, and default value). After 1016, method 1000 can stop.

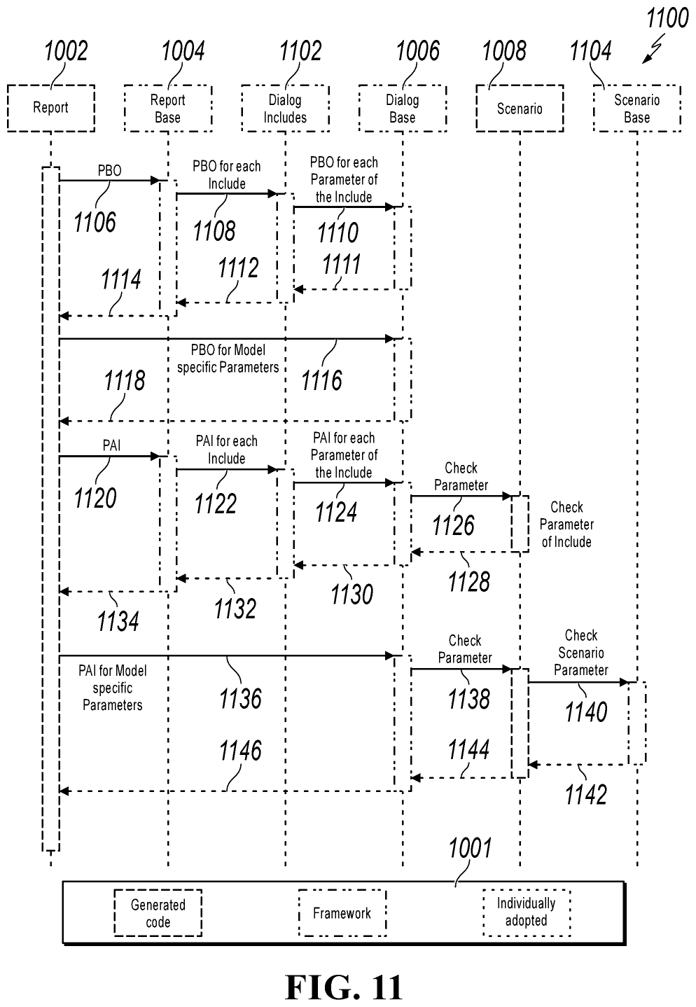

FIG. 11 is a swim diagram illustrating an example of a computer-implemented method 1100 for UI interaction, according to an implementation of the present disclosure. For clarity of presentation, the description that follows generally describes method 1100 in the context of the other figures in this description. However, it will be understood that method 1100 can be performed, for example, by any system, environment, software, and hardware, or a combination of systems, environments, software, and hardware, as appropriate. In some implementations, various steps of method 1100 can be run in parallel, in combination, in loops, or in any order.

In some implementations, while a user (for example, a model user) is editing parameters, all parameters (user-defined and included standard parameters) are checked each time the user presses an enter button (for example, on a computer keyboard) and when data generation is triggered. In the example of FIG. 11, parameters are checked separately.

At 1106, is the start of the Report 1002 rendering existing standard parameters into input fields on a UI (for example, refer to FIG. 9). Process before output (PBO) is the step processed before a UI is (re-)drawn on a screen. From 1106, method 1100 proceeds to 1108.

At 1108, the Report Base 1004 initiates a PBO for each include from the Dialog Includes 1102. From 1108, method 1100 proceeds to 1110.

At 1110, the Dialog Includes 1102 initiates a PBO for each parameter of each include from the Dialog Base 1006. From 1110, method 1100 proceeds to 1112.

At 1111, a return is performed from the Dialog Base 1006 to the Dialog Includes 1102. From 1111, method 1100 proceeds to 1111.

At 1112, a return is performed from the Dialog Includes 1102 to the Report Base 1004. From 1112, method 1100 proceeds to 1114.

At 1114, a return is performed from the Report Base 1004 to the Report 1002. From 1114, method 1100 proceeds to 1116.

At 1116, is the start of the Report 1002 rendering scenario-specific parameters on the UI (for example, refer to FIG. 9, NUMBER OF ARTISTS which is modelled in FIG. 2). The Report 1002 initiates a PBO with the scenario-specific parameters from the Dialog Base 1006. From 1116, method 1100 proceeds to 1118.

At 1118, a return is performed from the Dialog Base 1006 to the Report 1002. From 1118, method 1100 proceeds to 1120.

At 1120, is the start of the Report 1002 retrieving parameters and operating on them for standard parameters. A process after input (PAI) process is initiated to check the different parameters for validity. The Report 1002 initiates a PAI with the Report Base 1004. From 1120, method 1100 proceeds to 1122.

At 1122, the Report Base 1004 initiates a PAI for each include from the Dialog Includes 1102. From 1122, method 1100 proceeds to 1124.

At 1124, the Dialog Includes 1102 initiates a PAI for each parameter of each include from the Dialog Base 1006. From 1124, method 1100 proceeds to 1126.

At 1126, the Dialog Base 1006 initiates a check parameter with the Scenario 1008. In case of invalid parameter values (for example, an integer value <0 or used “work processes” >100%), an error message can be displayed on the UI and data generation prevented. Only after all parameters have been evaluated as valid is the data generation process triggered by the Report 1002. From 1126, method 1100 proceeds to 1128.

At 1128, a return is performed from the Scenario 1008 to the Dialog Base 1006. From 1128, method 1100 proceeds to 1130.

At 1130, a return is performed from the Dialog Base 1006 to the Dialog Includes 1102. From 1130, method 1100 proceeds to 1132.

At 1132, a return is performed from the Dialog Includes 1102 to the Report Base 1004. From 1132, method 1100 proceeds to 1134.

At 1134, a return is performed from the Report Base 1004 to the Report 1002. From 1134, method 1100 proceeds to 1136.

At 1136, is the start of the Report 1002 retrieving and checking model-specific input parameters. A PAI process is initiated to check the different model-specific parameters for validity. The Report 1002 initiates a PAI with the Dialog Base 1006. From 1136, method 1100 proceeds to 1138.

At 1138, the Dialog Base 1006 initiates a check parameter with the Scenario 1008. In some cases, an implementer can overwrite generated code to implement extensions to modeled checks. From 1138, method 1100 proceeds to 1140.

At 1140, the Scenario 1008 initiates a check scenario parameter with the Scenario Base 1104. Here, generic checks are performed (for example, validity of types) using modeled checks that can check against option modeled boundaries (for example, FIGS. 2, 220 and 212). A check is only processed if a minimum of one parameter (for example, FIGS. 2, 220 and 212) is defined. From 1140, method 1100 proceeds to 1142.

At 1142, a return is performed from the Scenario Base 1104 to the Scenario 1008. From 1142, method 1100 proceeds to 1146.

At 1144, a return is performed from the Scenario 1008 to the Dialog Base 1006. From 1144, method 1100 proceeds to 1148.

At 1146, a return is performed from the Dialog Base 1006 to the Report 1002. After 1146, method 1100 can stop.

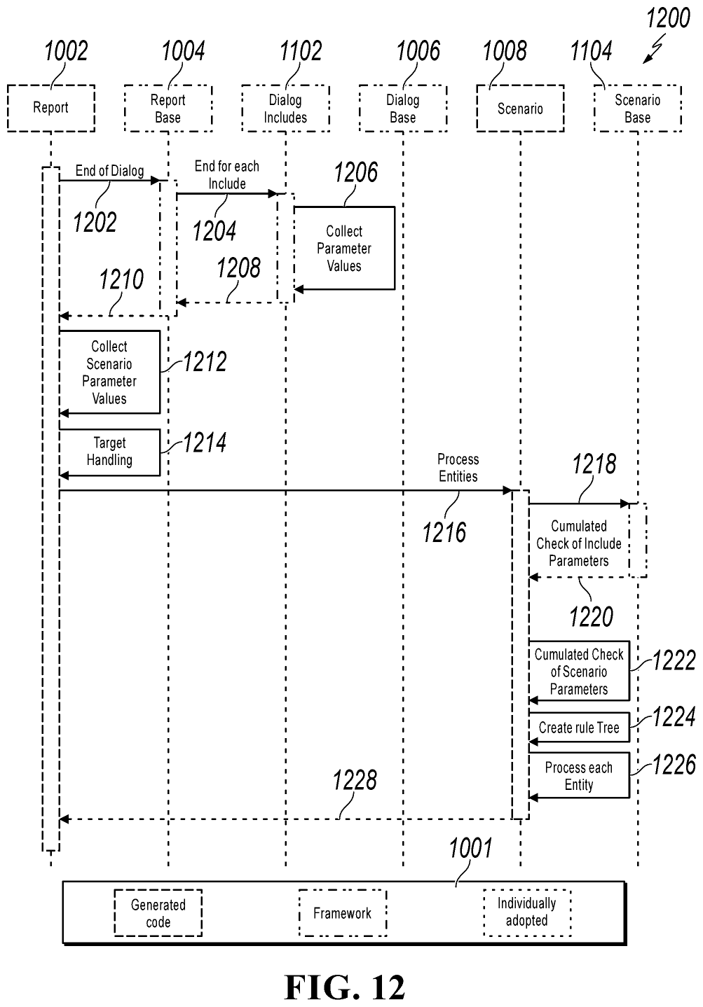

FIG. 12 is a swim diagram illustrating an example of a computer-implemented method 1200 for checking combinations of parameters, according to an implementation of the present disclosure. For clarity of presentation, the description that follows generally describes method 1200 in the context of the other figures in this description. However, it will be understood that method 1200 can be performed, for example, by any system, environment, software, and hardware, or a combination of systems, environments, software, and hardware, as appropriate. In some implementations, various steps of method 1200 can be run in parallel, in combination, in loops, or in any order.

In some implementations, when all parameters have been supplied and considered to be valid, then data generation can start. Parameters are checked in combination. This process starts when data generation is triggered (for example, pressing a start button on a GUI). In some instances, the parameter checks can to be adopted manually if required. In typical implementations, there are no combined parameter checks in the generated code because the combined parameters are scenario specific.

Collecting parameter values is obtaining the set of UI parameters and their values and passing them to a data generation scenario which might perform cumulative checks. Generated data can be sent to different types of persistency layers (for example, databases or files)—that is, “data targets”. Target handling means that prerequisite actions (if necessary) are performed to prepare a persistence layer for usage (for example, if data is sent to a remote database, a corresponding remote data base connection needs to be established, or if data is sent to a file, the file needs to be created/opened).

At 1202, at the end of a dialog all parameter values are collected from the single UI fields and are checked in combination. The Report 1002 initiates the collection and check from the Report Base 1004 based on a trigger (for example, pressing a start button on a GUI). From 1202, method 1200 proceeds to 1204.

At 1204, a stack is called. The Report Base 1004 calls the Dialog Base 1006 for each include. From 1204, method 1200 proceeds to 1206.

At 1206, parameters are collected by the Dialog Includes 1102 from different UI sections. From 1206, method 1200 proceeds to 1208.

At 1208, a return is performed from the Dialog Includes 1102 to the Report Base 1004. From 1208, method 1200 proceeds to 1210.

At 1210, a return is performed from the Report Base 1004 to the Report 1002. From 1210, method 1200 proceeds to 1212.

At 1212, the collected parameters are placed by the Report 1002 into a list for follow-up processing. From 1212, method 1200 proceeds to 1214.

At 1214, target handling is performed by the Report 1002. From 1214, method 1200 proceeds to 1216.

At 1216, a call to process the collected parameters is made to the Scenario 1008. From 1216, method 1200 proceeds to 1218.

At 1218, the combination of the standard parameters (administrative parameters and below) is validated by the Scenario Base 1104. From 1218, method 1200 proceeds to 1220.

At 1220, a return is performed from the Scenario Base 1104 to the Scenario 1008. From 1220, method 1200 proceeds to 1222.

At 1222, in some cases, a user can implement individual checks if the combination of the modeled parameters is considered to be valid. From 1222, method 1200 proceeds to 1224.

At 1224, a “rule tree” is created by the Scenario 1008, based on the model. The creation performs checks of the model itself (for example, if a field of a table (attribute of a node) exists). An analogy can be made to execution of a compiler where a data generation model is to be compiled. The output is an object tree. From 1224, method 1200 proceeds to 1226.

At 1226, each entity is processed by the Scenario 1008. From 1226, method 1200 proceeds to 1228.

At 1228, a return is performed from the Scenario 1008 to the Report 1002. After 1228, method 1200 can stop.

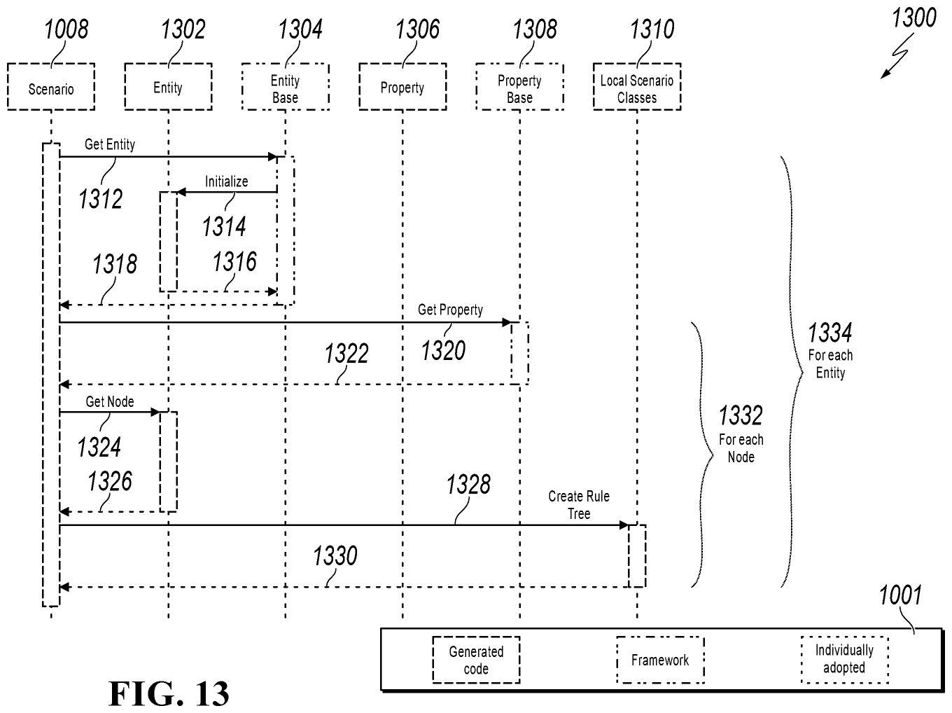

FIG. 13 is a swim diagram illustrating an example of a computer-implemented method 1300 for connecting model instances, according to an implementation of the present disclosure. For clarity of presentation, the description that follows generally describes method 1300 in the context of the other figures in this description. However, it will be understood that method 1300 can be performed, for example, by any system, environment, software, and hardware, or a combination of systems, environments, software, and hardware, as appropriate. In some implementations, various steps of method 1300 can be run in parallel, in combination, in loops, or in any order.

In some implementations, a global scenario class contains initialization and checks of parameters used by the report, and the global scenario class connects all model instances before code generation can begin. The main task is to create all used instances of a model, such as:
—Entities
Nodes
Properties on nodes
Attributes on nodes.

FIG. 13 shows how generated code for processing data generation for an entity and its associated nodes is processed. Each node is associated with a node property which determines a number of data records to be generated for a node. Each node is associated with a set of attribute rules. All the software entities are glued together by the data generation framework. Shown is a detailed view in to data generation—creating the rule tree.

At 1312, the Scenario 1008 requests an entity for processing from the Entity Base 1304. From 1312, method 1300 proceeds to 1314.

At 1314, the Entity Base 1304 requests specific information from the individual entity (Entity 1302). From 1314, method 1300 proceeds to 1316.

At 1316, a return is performed from the Entity 1302 to the Entity Base 1304 returning the requested specific information about the entity. From 1316, method 1300 proceeds to 1318.

At 1318, a return is performed from the Entity Base 1304 to the Scenario 1008. From 1318, method 1300 proceeds to 1320.

At 1320, the Scenario 1008 requests parameters of a property of a node from the Property Base 1308. From 1320, method 1300 proceeds to 1322.

At 1322, a return is performed from the Property Base 1308 to the Scenario 1008 returning the requested parameters of the property of the node. From 1322, method 1300 proceeds to 1324.

At 1324, a request is made from the Scenario 1008 to the Entity 1302 to obtain information about a specific node. From 1324, method 1300 proceeds to 1326.

At 1326, a return is performed from the Entity 1302 to the Scenario 1008 returning the requested information about the specific node. From 1326, method 1300 proceeds to 1328.

At 1328, the rule tree is created. In some cases, the rule tree can be serialized sent to different tasks in a parallel processing environment. A rule tree is the complete description of a scenario and includes a tree of objects (for example, a UI implementation in .NET, where a scenario corresponds to a screen, nodes are sub elements, such as sections of the screen. From 1328, method 1300 proceeds to 1330.

At 1330, a return is performed from the Local Scenario Classes 1310 to the Scenario 1008. After 1300, method 1300 can stop.

Note that 1332 and 1334 encompasses ranges of steps for each node and for each Entity 1302, respectively.

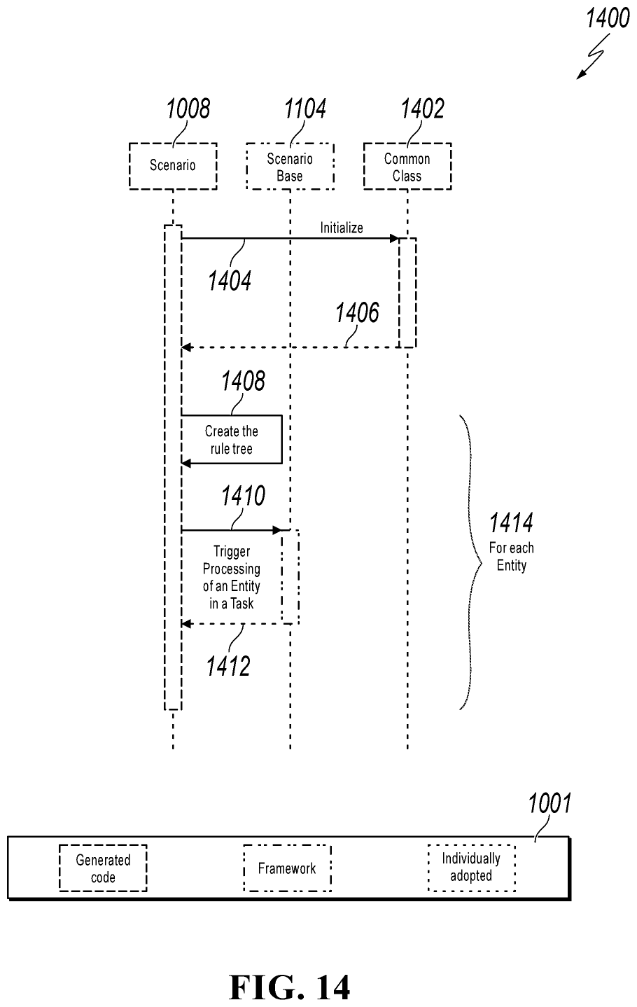

FIG. 14 is a swim diagram illustrating an example of a computer-implemented method 1400 for processing each entity, according to an implementation of the present disclosure. For clarity of presentation, the description that follows generally describes method 1400 in the context of the other figures in this description. However, it will be understood that method 1400 can be performed, for example, by any system, environment, software, and hardware, or a combination of systems, environments, software, and hardware, as appropriate. In some implementations, various steps of method 1400 can be run in parallel, in combination, in loops, or in any order.

In some implementations, processing of an entity means creating tasks regarding workload and executing the tasks in parallel. In some instances, algorithms for calculating data generator workload and a number of data generation tasks needs to be implemented manually as the logic required depends on the specific characteristics of a particular data generation scenario.

At 1404, Scenario 1008 requests initialization of a Common Class 1402, which is a generated empty hull where a modeler (for example, a person) can implement individual code. 1404 calls the initialization method of this class. If this modeler has implemented nothing, then an empty method is called and nothing happens. From 1404, method 1400 proceeds to 1406.

At 1406, the Common Class 1402 returns to the Scenario 1008. From 1406, method 1400 proceeds to 1408.

At 1408, the Scenario 1008 creates a rule tree (please refer to FIG. 13). From 1408, method 1400 proceeds to 1410.

At 1410, the Scenario 1008 triggers processing of an entity in a task from the Scenario Base 1104. Here, the model tree is taken, serialized and put into tasks. From 1410, method 1400 proceeds to 1414.

At 1412, the Scenario Base 1104 returns to the Scenario 1008. After 1412, method 1400 can stop.

Note that in some implementations (and as illustrated), 1408 and 1412 occur for each entity.

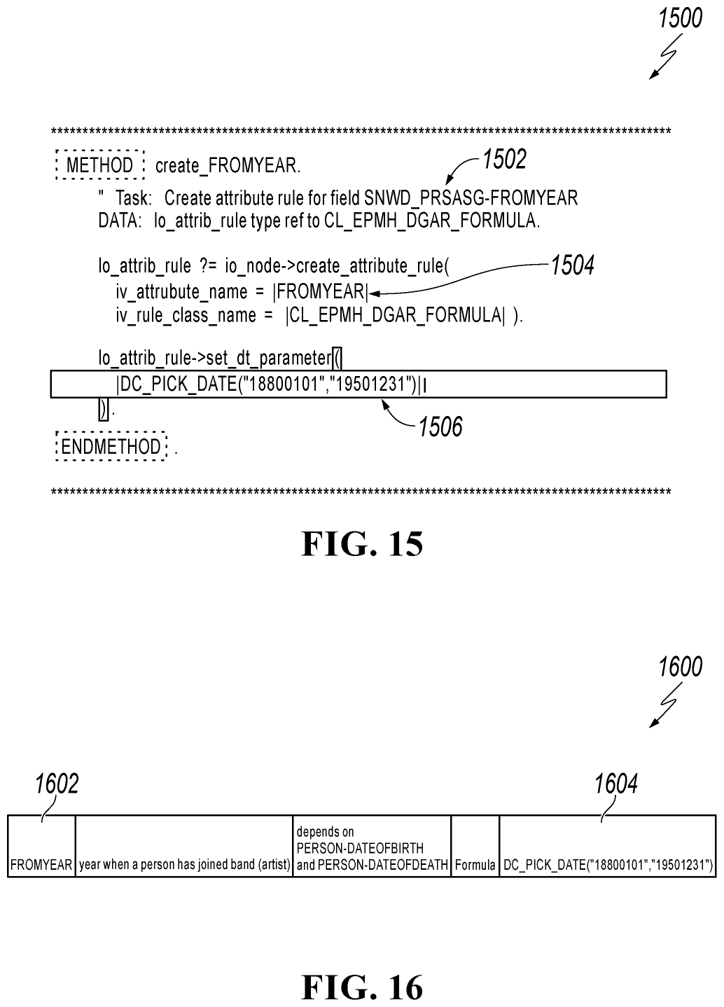

FIG. 15 is an example of an individual method implementation 1500 for an attribute rule, according to an implementation of the present disclosure. Local scenario classes are the base of each model and are responsible for creation of all attribute rule instances, which are embedded in nodes, which again are embedded in their associated entities. Per entity, a local class is generated. The code generator creates an individual method implementation for each attribute rule, which reduces manual effort enormously. As illustrated in FIG. 15, an attribute rule for database table SNWD_PRSASG column FROMYEAR 1502 is defined. Note the attribute name “FROMYEAR” 1504 and formula 1506. The attribute rule is generated from a corresponding line in a scenario definition UI (here, a spreadsheet) as illustrated in FIG. 16.

Turning to FIG. 16, FIG. 16 is a line 1600 in a scenario definition UI corresponding to definition of an attribute rule in FIG. 15, according to an implementation of the present disclosure. As illustrated in FIG. 16, attribute name 1602 and formula 1604 corresponds to the attribute name 1504 and formula 1506 in FIG. 15.

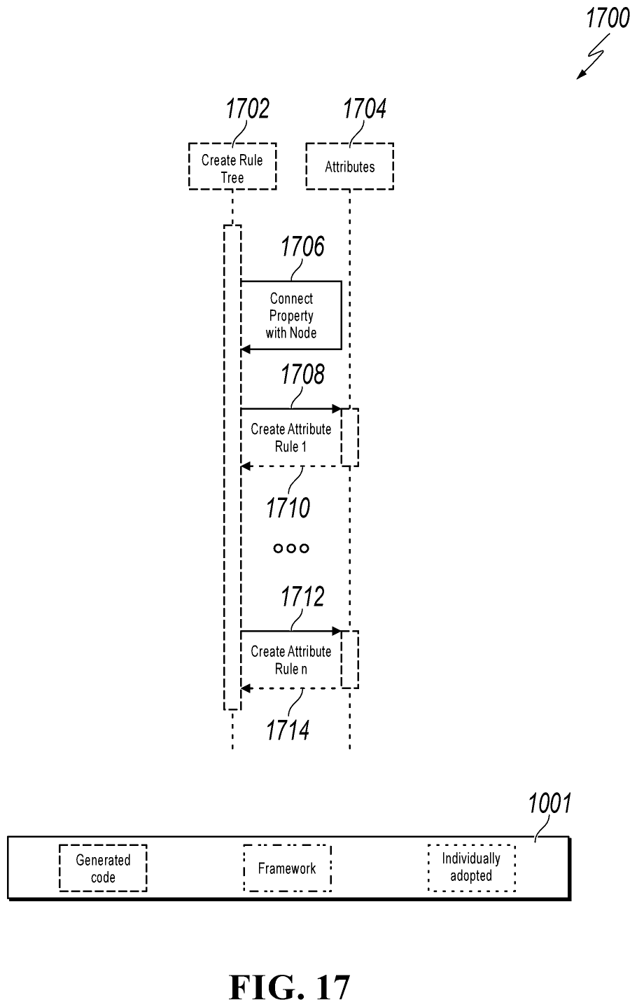

FIG. 17 is a swim diagram illustrating an example of a computer-implemented method 1700 for creating attribute rules, according to an implementation of the present disclosure. For clarity of presentation, the description that follows generally describes method 1700 in the context of the other figures in this description. However, it will be understood that method 1700 can be performed, for example, by any system, environment, software, and hardware, or a combination of systems, environments, software, and hardware, as appropriate. In some implementations, various steps of method 1700 can be run in parallel, in combination, in loops, or in any order.

In some implementations, the creation of attribute rules is a chain of calls. Method 1700 is part of “Create Rule Tree” (refer to FIG. 13, 1328) based on generated code.

At 1706, a Create Rule Tree 1702 connects a property to a node. From 1706, method 1700 proceeds to 1708.

At 1708, the Create Rule Tree 1702 requests creation of attribute rule 1 from Attributes 1704. From 1708, method 1700 proceeds to 1710.

At 1710, the Attributes 1704 returns class instances (which represent the different attribute rules of a node and will be processed during data generation) to the Create Rule Tree 1702. From 1710, method 1700 proceeds to 1712.

1712 and 1714 correspond to 1708 and 1710 performed repeatedly through attribute rule n. After 1714, method 1700 can stop.

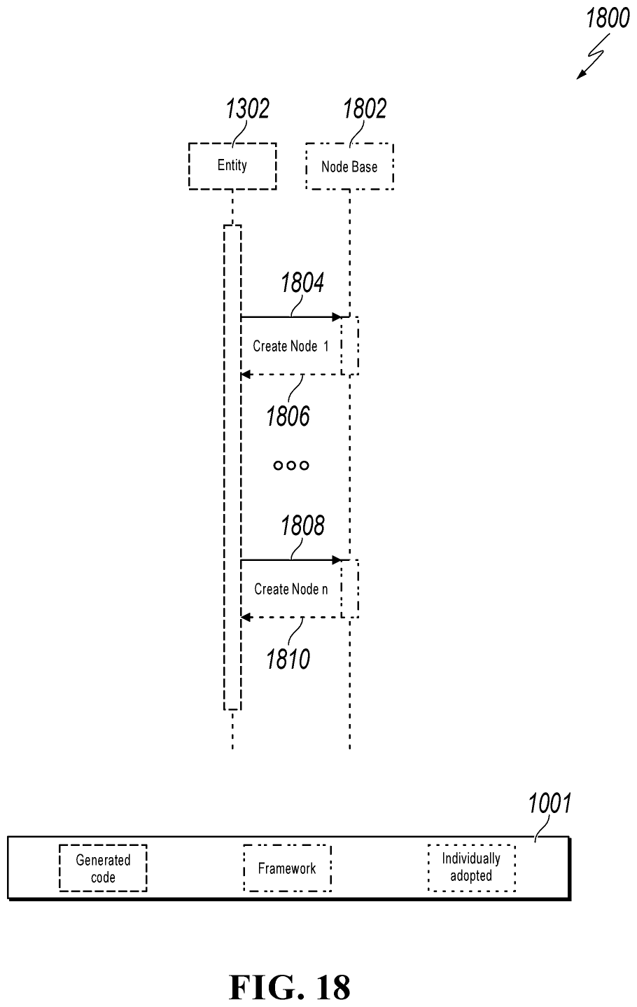

FIG. 18 is a swim diagram illustrating an example of a computer-implemented method 1800 for generating an entity class for each entity, according to an implementation of the present disclosure. For clarity of presentation, the description that follows generally describes method 1800 in the context of the other figures in this description. However, it will be understood that method 1800 can be performed, for example, by any system, environment, software, and hardware, or a combination of systems, environments, software, and hardware, as appropriate. In some implementations, various steps of method 1800 can be run in parallel, in combination, in loops, or in any order.

In some implementations, each entity class, contains the structure of its nodes. The entity class is generated based on the information specified in FIG. 4. For each entity, one entity class in generated. FIG. 17 is a subsequent call of the FIG. 18 phase of creating the rule tree.

At 1804, an Entity 1302 requests creation of a node 1 from a Node Base 1802. From 1804, method 1800 proceeds to 1806.

At 1806, the Node Base 1802 returns class instances to the entity 1302. The class instances represent different nodes of an entity and will be processed during data generation. Each node is responsible for triggering data generation for each attribute rule associated with it. From 1806, method 1800 proceeds to 1808.

1808 and 1810 correspond to 1804 and 1806 performed repeatedly through node rule n. After 1810, method 1800 can stop.

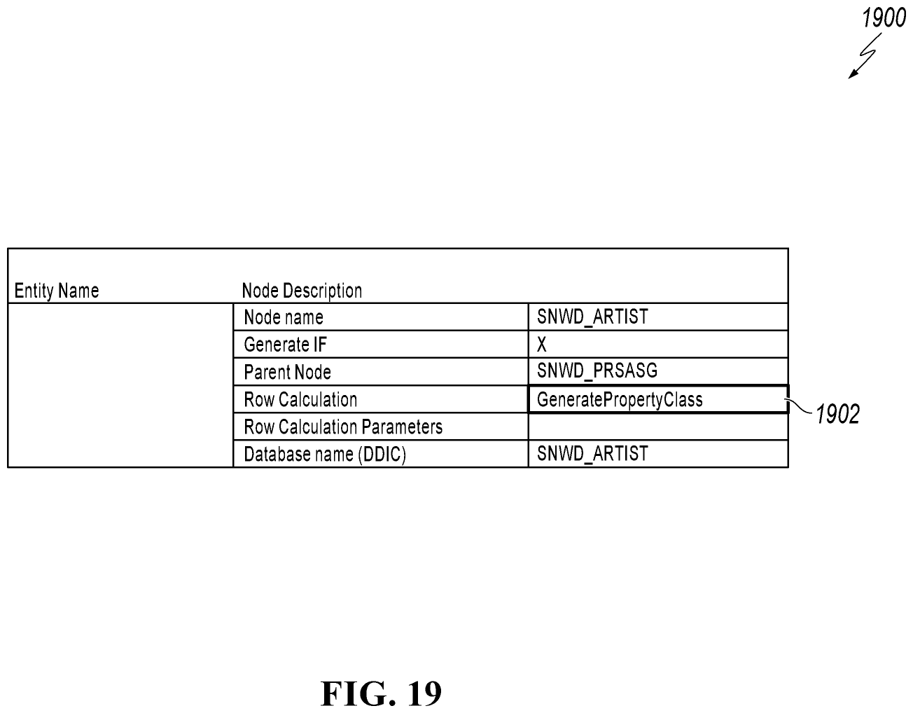

FIG. 19 is an example of an implementation of a specific property 1900, according to an implementation of the present disclosure. Generated tests create data of an entity only locally into buffers and only for the entity. Developers of rules can use this class for testing, if it is not desired to persist the data at the data base. Parameters with default values can also be generated in this manner. In some implementations, if a specific property implementation is required—“Row Calculation” can be set to a particular value (for example, “GeneratePropertyClass” as illustrated at 1902 in FIG. 19). This is needed if workload calculation of standard property classes is not sufficient.

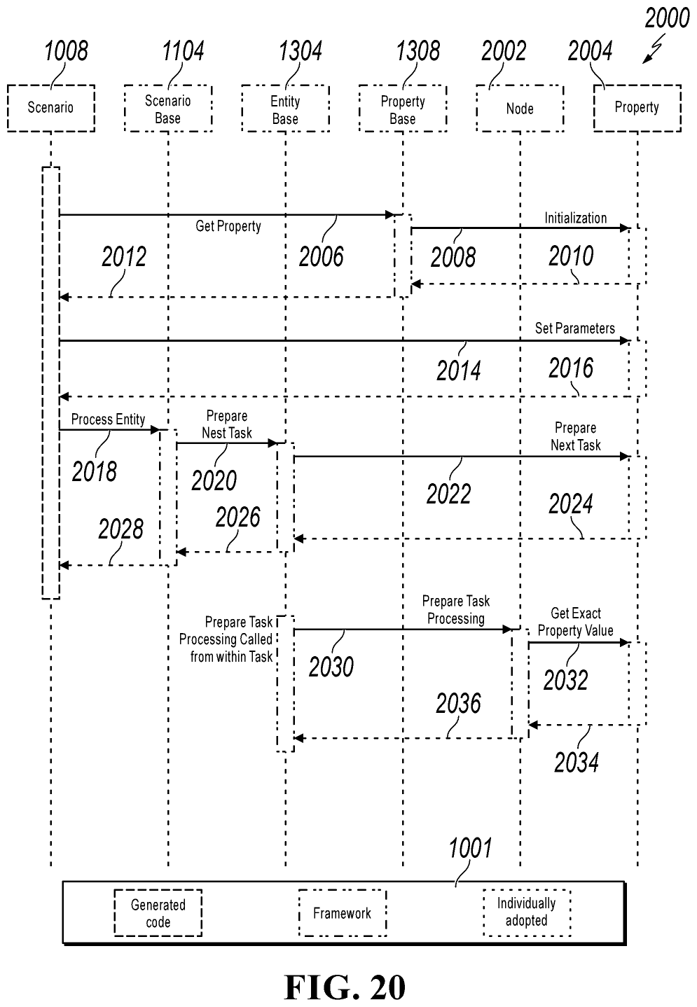

FIG. 20 is a swim diagram illustrating an example of a computer-implemented method 2000 for connecting model instances, according to an implementation of the present disclosure. For clarity of presentation, the description that follows generally describes method 2000 in the context of the other figures in this description. However, it will be understood that method 2000 can be performed, for example, by any system, environment, software, and hardware, or a combination of systems, environments, software, and hardware, as appropriate. In some implementations, various steps of method 2000 can be run in parallel, in combination, in loops, or in any order.

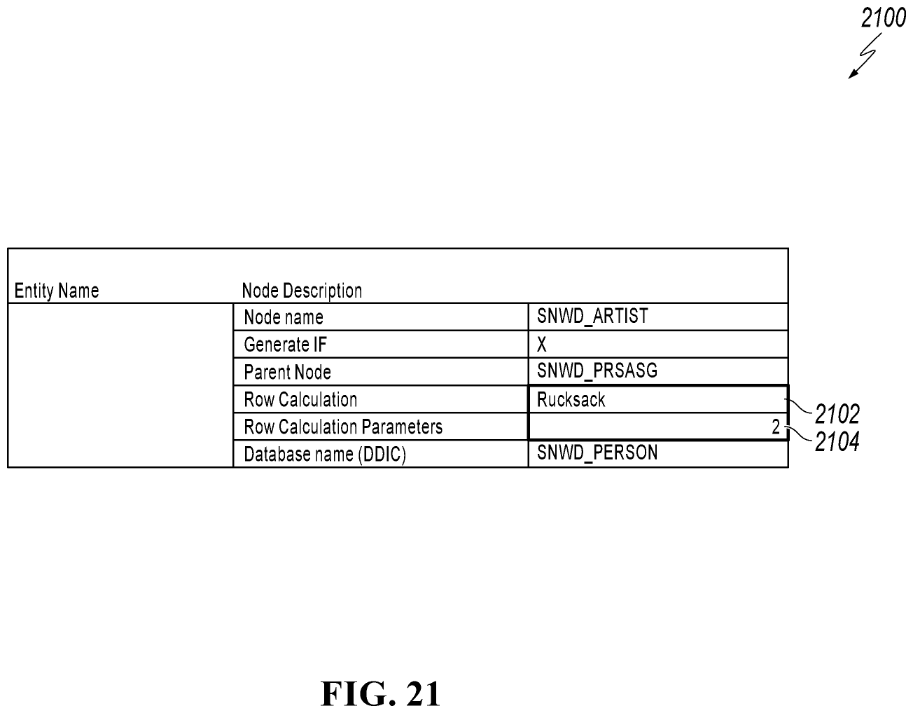

FIG. 20 describes how a workload is calculated and processed. The size of data to generate at the same time is necessarily limited to, for example, system resources and required computational performance. Accordingly, generation is divided into chunks. The size of a chunk can be calculated based on size information of the whole model. In some implementations, size information is defined in properties. Note that the individually adopted steps are called if rucksack processing (refer to FIG.21) is defined or an own property is implemented (refer to FIG.19).

In some implementations, a specific property class is fully embedded into the framework. Only some calls must be implemented. Methods of property classes must be implemented manually. Only empty methods are created here.

At a high-level, FIG. 20 describes the following steps:
1. UI parameters are passed to node properties (for example, a number of records to generate for a header node).
2. The data generation workload for an entity is subdivided into independent workload packages which are processed by “data generation tasks”. In some cases, these tasks can be processed in parallel which improves the overall speed of the data generation process.

At 2006, is the start of obtaining the modeled property (for example, FIG. 19, 1902) when creating the rule tree. A request is made from the Scenario 1008 to the Property Base 1308. From 2006, method 2000 proceeds to 2008.

At 2008, a request is made for initialization of a property from the Property Base 1308 to the Property 1306. From 2008, method 2000 proceeds to 2010.

At 2010, a return of the modeled property is performed from the Property 1306 to the Property Base 1308. From 2010, method 2000 proceeds to 2012.

At 2012, a return of the modeled property is performed from the Property Base 1308 to the Scenario 1008. From 2012, method 2000 proceeds to 2014.

At 2014, a request to set corresponding parameters (FIG: 19, row calculation parameters) is made from the Scenario 1008 to the Property 1306. From 2014, method 2000 proceeds to 2016.

At 2016, a return is performed from the Property 1306 to the Scenario 1008. From 2016, method 2000 proceeds to 2018.

At 2018, is the start of creating the single tasks. A request to process entities is made from the Scenario 1008 to the Scenario Base 1104. From 2018, method 2000 proceeds to 2020.

At 2020, a request to create the single tasks based on property size is sent from the Scenario Base 1104 to the Entity Base 1304. From 2020, method 2000 proceeds to 2022.

At 2022, a request is made from the Entity Base 1304 to a method in an individual implemented property (Property 1306). From 2022, method 2000 proceeds to 2024.

At 2024, a return is performed from the Property 1306 to the Entity Base 1304. From 2024, method 2000 proceeds to 2026.

At 2026, a return is performed from the Entity Base 1304 to the Scenario Base 1104. From 2026, method 2000 proceeds to 2028.

At 2028, a return is performed from the Scenario Base 1104 to the Scenario 1008. From 2028, method 2000 proceeds to 2030.

At 2030, within tasks, size values from properties are required to defining the size of the tables that are to be filled with data. A request to prepare task processing is made from the Entity Base 1304 to a Node 2002. From 2030, method 2000 proceeds to 2032.

At 2032, an exact property value is requested from an implemented property (Property 1306) by the Node 2002. From 2022, method 2000 proceeds to 2024.

At 2034, a return of the obtained exact property value is performed from the Property 1306 to the Node 2002. From 2024, method 2000 proceeds to 2026.

At 2036, a return is performed from the Node 2002 to the Entity Base 1304. After 2036, method 2000 can stop.

FIG. 21 is an example of class used for common used objects 2100, according to an implementation of the present disclosure. The class used for common used objects contains all parts of a project that are globally used, global user-defined constants, and user-defined code for processing scenario-specific behavior. The concept of creating sizes of table entries and some predefined values separately from column wise creation is called “Rucksack Concept”. For example, as illustrated in FIG. 21, when used for “Row Calculation” (the value 2102 of “Rucksack” is entered as a rule) and “Row Calculation Parameters” value 2014 is filled with an average number of table entries (here “2”) per entry of its parent table. Initialization of this artifact is performed once for each scenario. When “rucksack” is defined, it means that the “individually adopted” part of FIG. 20 is implemented.

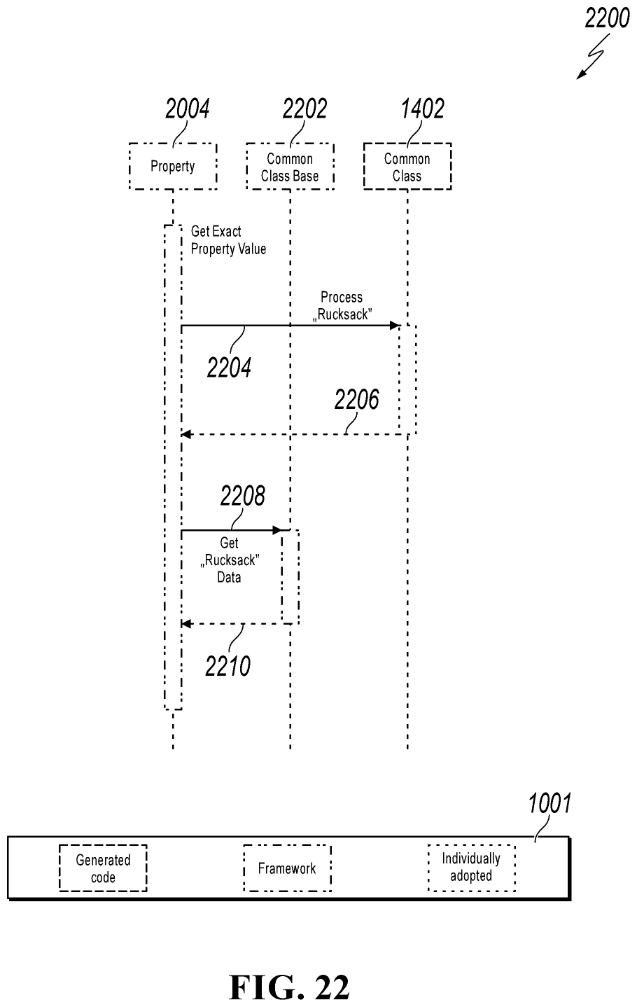

FIG. 22 is a swim diagram illustrating an example of a computer-implemented method 2200 for specifying a number of table entries to be created, according to an implementation of the present disclosure. For clarity of presentation, the description that follows generally describes method 2200 in the context of the other figures in this description. However, it will be understood that method 2200 can be performed, for example, by any system, environment, software, and hardware, or a combination of systems, environments, software, and hardware, as appropriate. In some implementations, various steps of method 2200 can be run in parallel, in combination, in loops, or in any order.

In some implementations, at runtime, code may be called that specifies (for example, a number of table entries to be created that is handled by so-called properties. But if the standard properties are not sufficient, then the number of table entries to be created must be coded manually.

At 2204, the Property 2004 requests an exact property value from a Common Class 1402 using the rucksack concept described in FIG. 21. From 2204, method 2200 proceeds to 2206.

At 2206, the Common Class 1402 returns the number of data records to be generated for a node to the Property 2004. From 2206, method 2200 proceeds to 2208.

At 2208, the Property 2004 requests rucksack data from a Common Class Base 2202. From 2208, method 2200 proceeds to 2210.

At 2210, the Common Class Base 2202 returns “Rucksack data” to the Property 2004. Data can be generated/supplied by the common class and can be copied to fields of a node and/or the data can be used for calculating values of node fields. Copying/accessing “Rucksack data” to node fields is performed by attribute rules specifically supplied for this purpose. After 2210, method 2200 can stop.

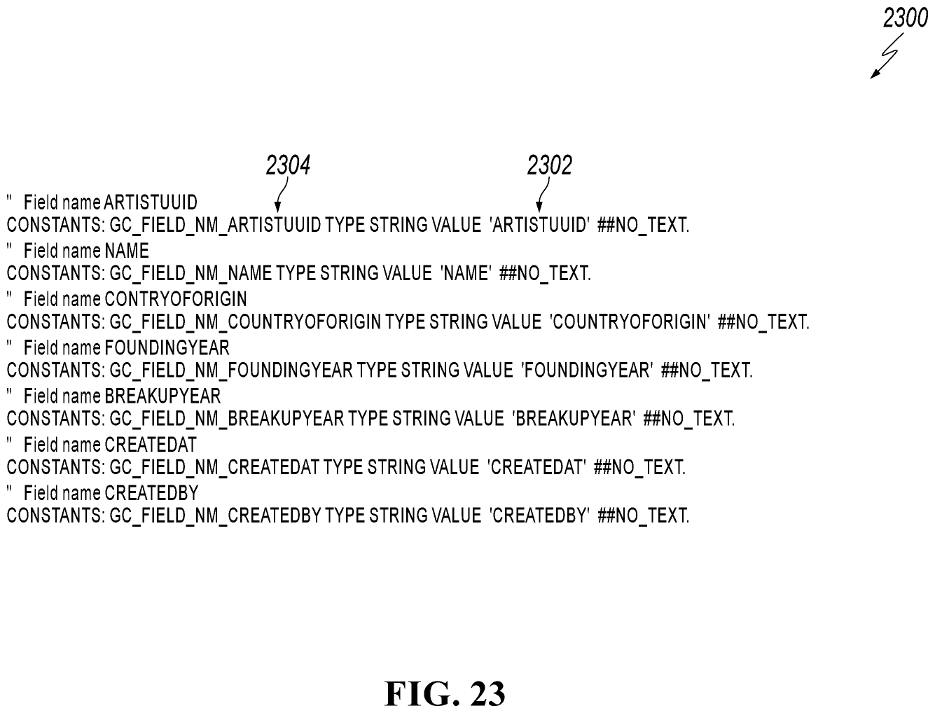

FIG. 23 is an example of an interface artifact 2300 describing database table structures, according to an implementation of the present disclosure. In some implementations, one interface is generated per database table. Interfaces provide a name for each column of a database table. Names are used for encapsulation of database column names, and with this technique, a syntax check can be used to find possible typographical errors and developer studio code completion also lists all defined names. For example, in FIG. 23, a database column name is “ARTISTUUID” (2302) and the corresponding name in coding is “GC_FIELD_NM_ARTISTUUID” (2304). Typos in “GC_FIELD_NM_ARTISTUUID” are recognized by syntax checks and would be indicated at design time, while typos in “ARTISTUUID” would not be recognized and would be indicated at the earliest in runtime.

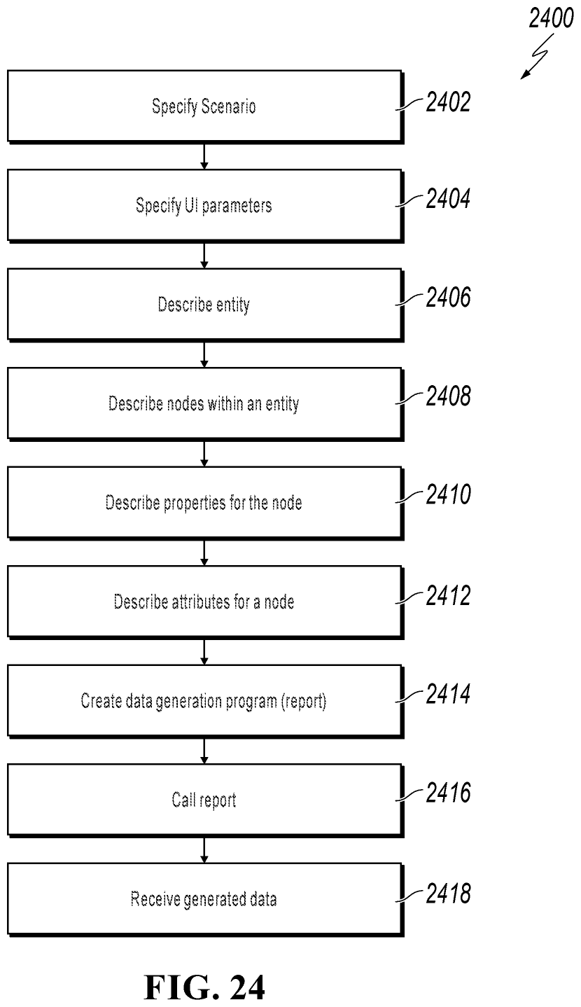

FIG. 24 is a flowchart illustrating an example of a computer-implemented method for creation of data generation code using high-level modeling descriptions, according to an implementation of the present disclosure. For clarity of presentation, the description that follows generally describes method 2400 in the context of the other figures in this description. However, it will be understood that method 2400 can be performed, for example, by any system, environment, software, and hardware, or a combination of systems, environments, software, and hardware, as appropriate. In some implementations, various steps of method 2400 can be run in parallel, in combination, in loops, or in any order.

At 2402, a scenario is specified for data generation. From 2402, method 2400 proceeds to 2404.

At 2404, user interface parameters associated with a data generation program and for controlling the data generation are specified. From 2404, method 2400 proceeds to 2406.

At 2406, one or more entities associated with the scenario are described. In some implementations, each entity of the one or more entities describes a collection of semantically related persistences. From 2406, method 2400 proceeds to 2408.

At 2408, one or more nodes associated with each entity of the one or more entities are described. In some implementations, each node of the one or more nodes represents a persistency used for storing the generated data. From 2408, method 2400 proceeds to 2410.

At 2410, one or more properties associated with each node of the one or more nodes are described. In some implementations, each property of the one or more properties describes behavior of a particular node and is used to calculate a number of entries to be created in the particular node. From 2410, method 2400 proceeds to 2412.

At 2412, one or more attributes for each node of the one or more nodes are described. In some implementations, each attribute of the one or more attributes corresponds to a column of a particular persistency and describes data to be generated to fill the column. In some implementations, an attribute rule is defined for an attribute, and wherein the attribute rule implements a particular algorithm for generating data. In some implementations, the attribute rule is associated with one or more parameters used to specify a particular behavior of the attribute rule. From 2412, method 2400 proceeds to 2414.

At 2414, the data generation program code is created. From 2414, method 2400 proceeds to 2416.

At 2416, the data generation program to generate data is called. From 2416, method 2400 proceeds to 2418.

At 2418, generated data is received. After 2418, method 2400 can stop.

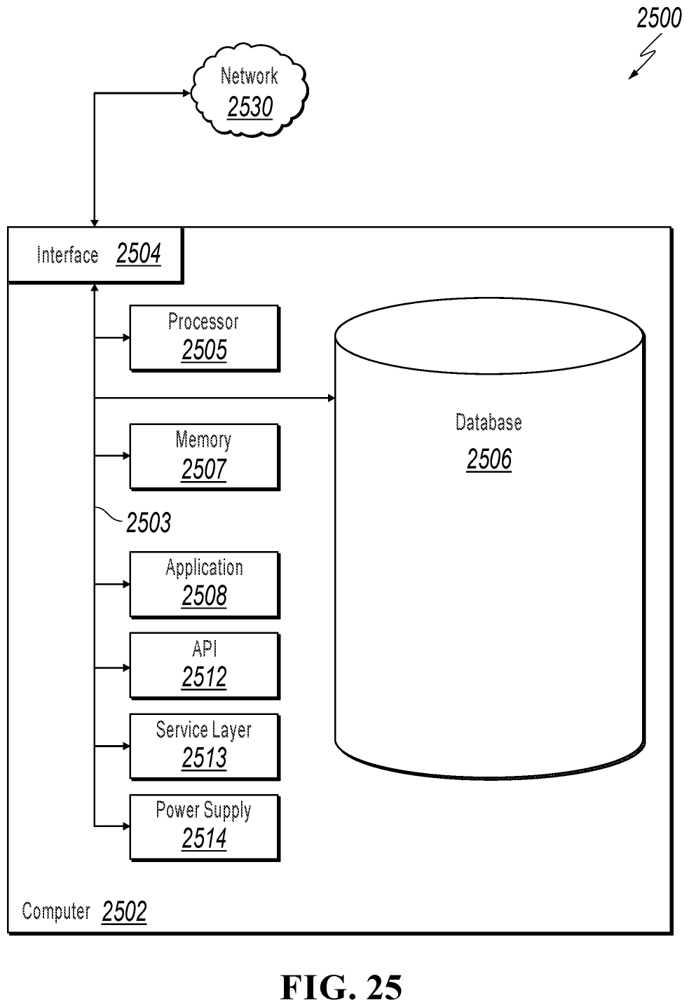

FIG. 25 is a block diagram illustrating an example of a computer-implemented System 2500 used to provide computational functionalities associated with described algorithms, methods, functions, processes, flows, and procedures, according to an implementation of the present disclosure. In the illustrated implementation, System 2500 includes a Computer 2502 and a Network 2530.

The illustrated Computer 2502 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 2502 can include an input device, such as a keypad, keyboard, or touch screen, or a combination of input devices that can accept user information, and an output device that conveys information associated with the operation of the Computer 2502, including digital data, visual, audio, another type of information, or a combination of types of information, on a graphical-type user interface (UI) (or GUI) or other UI.

The Computer 2502 can serve in a role in a distributed computing system as, for example, a client, network component, a server, or a database or another persistency, or a combination of roles for performing the subject matter described in the present disclosure. The illustrated Computer 2502 is communicably coupled with a Network 2530. In some implementations, one or more components of the Computer 2502 can be configured to operate within an environment, or a combination of environments, including cloud-computing, local, or global.

At a high level, the Computer 2502 is an electronic computing device operable to receive, transmit, process, store, or manage data and information associated with the described subject matter. According to some implementations, the Computer 2502 can also include or be communicably coupled with a server, such as an application server, e-mail server, web server, caching server, or streaming data server, or a combination of servers.

The Computer 2502 can receive requests over Network 2530 (for example, from a client software application executing on another Computer 2502) and respond to the received requests by processing the received requests using a software application or a combination of software applications. In addition, requests can also be sent to the Computer 2502 from internal users (for example, from a command console or by another internal access method), external or third-parties, or other entities, individuals, systems, or computers.

Each of the components of the Computer 2502 can communicate using a System Bus 2503. In some implementations, any or all of the components of the Computer 2502, including hardware, software, or a combination of hardware and software, can interface over the System Bus 2503 using an application programming interface (API) 2512, a Service Layer 2513, or a combination of the API 2512 and Service Layer 2513. The API 2512 can include specifications for routines, data structures, and object classes. The API 2512 can be either computer-language independent or dependent and refer to a complete interface, a single function, or even a set of APIs. The Service Layer 2513 provides software services to the Computer 2502 or other components (whether illustrated or not) that are communicably coupled to the Computer 2502. The functionality of the Computer 2502 can be accessible for all service consumers using the Service Layer 2513. Software services, such as those provided by the Service Layer 2513, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 2502, alternative implementations can illustrate the API 2512 or the Service Layer 2513 as stand-alone components in relation to other components of the Computer 2502 or other components (whether illustrated or not) that are communicably coupled to the Computer 2502. Moreover, any or all parts of the API 2512 or the Service Layer 2513 can be implemented as a child or a sub-module of another software module, enterprise application, or hardware module without departing from the scope of the present disclosure.

The Computer 2502 includes an Interface 2504. Although illustrated as a single Interface 2504, two or more Interfaces 2504 can be used according to particular needs, desires, or particular implementations of the Computer 2502. The Interface 2504 is used by the Computer 2502 for communicating with another computing system (whether illustrated or not) that is communicatively linked to the Network 2530 in a distributed environment. Generally, the Interface 2504 is operable to communicate with the Network 2530 and includes logic encoded in software, hardware, or a combination of software and hardware. More specifically, the Interface 2504 can include software supporting one or more communication protocols associated with communications such that the Network 2530 or hardware of Interface 2504 is operable to communicate physical signals within and outside of the illustrated Computer 2502.

The Computer 2502 includes a Processor 2505. Although illustrated as a single Processor 2505, two or more Processors 2505 can be used according to particular needs, desires, or particular implementations of the Computer 2502. Generally, the Processor 2505 executes instructions and manipulates data to perform the operations of the Computer 2502 and any algorithms, methods, functions, processes, flows, and procedures as described in the present disclosure.

The Computer 2502 also includes a Database 2506 that can hold data for the Computer 2502, another component communicatively linked to the Network 2530 (whether illustrated or not), or a combination of the Computer 2502 and another component. For example, Database 2506 can be an in-memory or conventional database storing data consistent with the present disclosure. In some implementations, Database 2506 can be a combination of two or more different database types (for example, a hybrid in-memory and conventional database) according to particular needs, desires, or particular implementations of the Computer 2502 and the described functionality. Although illustrated as a single Database 2506, two or more databases of similar or differing types can be used according to particular needs, desires, or particular implementations of the Computer 2502 and the described functionality. While Database 2506 is illustrated as an integral component of the Computer 2502, in alternative implementations, Database 2506 can be external to the Computer 2502.

The Computer 2502 also includes a Memory 2507 that can hold data for the Computer 2502, another component or components communicatively linked to the Network 2530 (whether illustrated or not), or a combination of the Computer 2502 and another component. Memory 2507 can store any data consistent with the present disclosure. In some implementations, Memory 2507 can be a combination of two or more different types of memory (for example, a combination of semiconductor and magnetic storage) according to particular needs, desires, or particular implementations of the Computer 2502 and the described functionality. Although illustrated as a single Memory 2507, two or more Memories 2507 or similar or differing types can be used according to particular needs, desires, or particular implementations of the Computer 2502 and the described functionality. While Memory 2507 is illustrated as an integral component of the Computer 2502, in alternative implementations, Memory 2507 can be external to the Computer 2502.

The Application 2508 is an algorithmic software engine providing functionality according to particular needs, desires, or particular implementations of the Computer 2502, particularly with respect to functionality described in the present disclosure. For example, Application 2508 can serve as one or more components, modules, or applications. Further, although illustrated as a single Application 2508, the Application 2508 can be implemented as multiple Applications 2508 on the Computer 2502. In addition, although illustrated as integral to the Computer 2502, in alternative implementations, the Application 2508 can be external to the Computer 2502.

The Computer 2502 can also include a Power Supply 2514. The Power Supply 2514 can include a rechargeable or non-rechargeable battery that can be configured to be either user- or non-user-replaceable. In some implementations, the Power Supply 2514 can include power-conversion or management circuits (including recharging, standby, or another power management functionality). In some implementations, the Power Supply 2514 can include a power plug to allow the Computer 2502 to be plugged into a wall socket or another power source to, for example, power the Computer 2502 or recharge a rechargeable battery.

There can be any number of Computers 2502 associated with, or external to, a computer system containing Computer 2502, each Computer 2502 communicating over Network 2530. Further, the term “client,” “user,” or other appropriate terminology can be used interchangeably, as appropriate, without departing from the scope of the present disclosure. Moreover, the present disclosure contemplates that many users can use one Computer 2502, or that one user can use multiple computers 2502.

Described implementations of the subject matter can include one or more features, alone or in combination.

For example, in a first implementation, a computer-implemented method, comprising: specifying a scenario for data generation; specifying user interface parameters associated with a data generation program and for controlling the data generation; describing one or more entities associated with the scenario; describing one or more nodes associated with each entity of the one or more entities; describing one or more properties associated with each node of the one or more nodes; describing one or more attributes for each node of the one or more nodes; creating the data generation program code; calling the data generation program to generate data; and receiving generated data.

The foregoing and other described implementations can each, optionally, include one or more of the following features:

A first feature, combinable with any of the following features, wherein each entity of the one or more entities describes a collection of semantically related persistences.

A second feature, combinable with any of the previous or following features, wherein each node of the one or more nodes represents a persistency used for storing the generated data.

A third feature, combinable with any of the previous or following features, wherein each property of the one or more properties describes behavior of a particular node and is used to calculate a number of entries to be created in the particular node.

A fourth feature, combinable with any of the previous or following features, wherein each attribute of the one or more attributes corresponds to a column of a particular persistency and describes data to be generated to fill the column.

A fifth feature, combinable with any of the previous or following features, wherein an attribute rule is defined for an attribute, and wherein the attribute rule implements a particular algorithm for generating data.

A sixth feature, combinable with any of the previous or following features, wherein the attribute rule is associated with one or more parameters used to specify a particular behavior of the attribute rule.

In a second implementation, a non-transitory, computer-readable medium storing one or more instructions executable by a computer system to perform operations comprising: specifying a scenario for data generation; specifying user interface parameters associated with a data generation program and for controlling the data generation; describing one or more entities associated with the scenario; describing one or more nodes associated with each entity of the one or more entities; describing one or more properties associated with each node of the one or more nodes; describing one or more attributes for each node of the one or more nodes; creating the data generation program code; calling the data generation program to generate data; and receiving generated data.

The foregoing and other described implementations can each, optionally, include one or more of the following features:

A first feature, combinable with any of the following features, wherein each entity of the one or more entities describes a collection of semantically related persistences.

A second feature, combinable with any of the previous or following features, wherein each node of the one or more nodes represents a persistency used for storing the generated data.

A third feature, combinable with any of the previous or following features, wherein each property of the one or more properties describes behavior of a particular node and is used to calculate a number of entries to be created in the particular node.

A fourth feature, combinable with any of the previous or following features, wherein each attribute of the one or more attributes corresponds to a column of a particular persistency and describes data to be generated to fill the column.

A fifth feature, combinable with any of the previous or following features, wherein an attribute rule is defined for an attribute, and wherein the attribute rule implements a particular algorithm for generating data.

A sixth feature, combinable with any of the previous or following features, wherein the attribute rule is associated with one or more parameters used to specify a particular behavior of the attribute rule.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: specifying a scenario for data generation; specifying user interface parameters associated with a data generation program and for controlling the data generation; describing one or more entities associated with the scenario; describing one or more nodes associated with each entity of the one or more entities; describing one or more properties associated with each node of the one or more nodes; describing one or more attributes for each node of the one or more nodes; creating the data generation program code; calling the data generation program to generate data; and receiving generated data.

The foregoing and other described implementations can each, optionally, include one or more of the following features:

A first feature, combinable with any of the following features, wherein each entity of the one or more entities describes a collection of semantically related persistences.

A second feature, combinable with any of the previous or following features, wherein each node of the one or more nodes represents a persistency used for storing the generated data.

A third feature, combinable with any of the previous or following features, wherein each property of the one or more properties describes behavior of a particular node and is used to calculate a number of entries to be created in the particular node.

A fourth feature, combinable with any of the previous or following features, wherein each attribute of the one or more attributes corresponds to a column of a particular persistency and describes data to be generated to fill the column.

A fifth feature, combinable with any of the previous or following features, wherein an attribute rule is defined for an attribute, and wherein the attribute rule implements a particular algorithm for generating data.

A sixth feature, combinable with any of the previous or following features, wherein the attribute rule is associated with one or more parameters used to specify a particular behavior of the attribute rule.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
specifying a scenario for data generation;
specifying user interface parameters associated with a data generation program and for controlling the data generation;
describing one or more entities associated with the scenario;
describing one or more nodes associated with each entity of the one or more entities;
describing one or more properties associated with each node of the one or more nodes;
describing one or more attributes for each node of the one or more nodes;
creating the data generation program code;
calling the data generation program to generate data; and
receiving generated data.

2. The computer-implemented method of claim 1, wherein each entity of the one or more entities describes a collection of semantically related persistences.

3. The computer-implemented method of claim 1, wherein each node of the one or more nodes represents a persistency used for storing the generated data.

4. The computer-implemented method of claim 3, wherein each property of the one or more properties describes behavior of a particular node and is used to calculate a number of entries to be created in the particular node.

5. The computer-implemented method of claim 3, wherein each attribute of the one or more attributes corresponds to a column of a particular persistency and describes data to be generated to fill the column.

6. The computer-implemented method of claim 5, wherein an attribute rule is defined for an attribute, and wherein the attribute rule implements a particular algorithm for generating data.

7. The computer-implemented method of claim 6, wherein the attribute rule is associated with one or more parameters used to specify a particular behavior of the attribute rule.

8. A non-transitory, computer-readable medium storing one or more instructions executable by a computer system to perform operations comprising:
specifying a scenario for data generation;
specifying user interface parameters associated with a data generation program and for controlling the data generation;
describing one or more entities associated with the scenario;
describing one or more nodes associated with each entity of the one or more entities;
describing one or more properties associated with each node of the one or more nodes;
describing one or more attributes for each node of the one or more nodes;
creating the data generation program code;
calling the data generation program to generate data; and
receiving generated data.

9. The non-transitory, computer-readable medium of claim 8, wherein each entity of the one or more entities describes a collection of semantically related persistences.

10. The non-transitory, computer-readable medium of claim 8, wherein each node of the one or more nodes represents a persistency used for storing the generated data.

11. The non-transitory, computer-readable medium of claim 10, wherein each property of the one or more properties describes behavior of a particular node and is used to calculate a number of entries to be created in the particular node.

12. The non-transitory, computer-readable medium of claim 10, wherein each attribute of the one or more attributes corresponds to a column of a particular persistency and describes data to be generated to fill the column.

13. The non-transitory, computer-readable medium of claim 12, wherein an attribute rule is defined for an attribute, and wherein the attribute rule implements a particular algorithm for generating data.

14. The non-transitory, computer-readable medium of claim 13, wherein the attribute rule is associated with one or more parameters used to specify a particular behavior of the attribute rule.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
specifying a scenario for data generation;
specifying user interface parameters associated with a data generation program and for controlling the data generation;
describing one or more entities associated with the scenario;
describing one or more nodes associated with each entity of the one or more entities;
describing one or more properties associated with each node of the one or more nodes;
describing one or more attributes for each node of the one or more nodes;
creating the data generation program code;
calling the data generation program to generate data; and
receiving generated data.

16. The computer-implemented system of claim 15, wherein each entity of the one or more entities describes a collection of semantically related persistences.

17. The computer-implemented system of claim 15, wherein each node of the one or more nodes represents a persistency used for storing the generated data.

18. The computer-implemented system of claim 17, wherein each property of the one or more properties describes behavior of a particular node and is used to calculate a number of entries to be created in the particular node.

19. The computer-implemented system of claim 17, wherein each attribute of the one or more attributes corresponds to a column of a particular persistency and describes data to be generated to fill the column.

20. The computer-implemented system of claim 19, wherein an attribute rule is defined for an attribute, and wherein the attribute rule implements a particular algorithm for generating data, and wherein the attribute rule is associated with one or more parameters used to specify a particular behavior of the attribute rule.
